(19) United States
(12) Patent Application Publication
(10) Pub. No.: US 2026/0019661 A1
(43) Pub. Date: Jan. 15, 2026

(54) VIDEO LIVESTREAMING-BASED INTERACTION METHOD AND APPARATUS, DEVICE, STORAGE MEDIUM, AND COMPUTER PROGRAM PRODUCT

(71) Applicant: TENCENT TECHNOLOGY (SHENZHEN) COMPANY LMITED, Shenzhen (CN)

(72) Inventor: Shangzhen ZHENG, Shenzhen (CN)

(73) Assignee: TENCENT TECHNOLOGY (SHENZHEN) COMPANY LMITED, Shenzhen (CN)

(21) Appl. No.: 19/338,145

(22) Filed: Sep. 24, 2025

Related U.S. Application Data
(63) Continuation of application No. PCT/CN2024/106752, filed on Jul. 22, 2024.

(30) Foreign Application Priority Data
Sep. 25, 2023 (CN) 202311246664.1

(51) Int. Cl. H04N 21/431; H04N 21/2187; H04N 21/239; H04N 21/478; H04N 21/81

(52) U.S. Cl. CPC H04N 21/4316; H04N 21/2187; H04N 21/2393; H04N 21/47815; H04N 21/812

(57) ABSTRACT

A video livestreaming-based interaction method, apparatus, and computer-readable storage medium for managing viewer-initiated information promotion in livestreaming environments. The method receives information promotion requests from requesting viewer accounts associated with a livestreamer's video livestreaming room. These requests are displayed in the video livestreaming image for the livestreamer account. Upon receiving a promotion confirmation operation selecting a target request, corresponding target promotion information is displayed in the video livestreaming image and pushed to viewer accounts in the livestreaming room. This approach enables interactive content promotion where viewers can request information display while maintaining livestreamer control over what content is actually promoted to the audience.

### CROSS-REFERENCE TO RELATED APPLICATIONS

This application is a continuation application of International Application No. PCT/CN2024/106752 filed on Jul. 22, 2024 which claims priority to Chinese Patent Application No. 202311246664.1, filed with the China National Intellectual Property Administration on Sep. 25, 2023, the disclosures of each being incorporated by reference herein in their entireties.

### FIELD

The disclosure relates to the field of computer technologies, a video livestreaming-based interaction method and apparatus, a computer device, a storage medium, and a computer program product.

### BACKGROUND

With the development of information technologies, information interaction manners are increasingly diversified. For example, to make information known by more people, a livestreaming technology may be used for implementation.

In the related art, to expand a range of information promotion, a user may choose to perform information promotion in a video livestreaming room. Information promotion in a livestreaming room is an extension of a promotion manner. The user may need to negotiate with an entity holding a livestreamer account in advance, to agree on promotion information displayed in a video livestreaming room of the livestreamer account. After the agreement, the entity holding the livestreamer account may develop a plan for displaying the promotion information. After live streaming begins, the promotion information may be displayed according to a scheduled plan.

However, a current information promotion manner in livestreaming rooms may require lots of manual preparations in advance, resulting in low efficiency and a need for improvement.

### SUMMARY

Provided are a video livestreaming-based interaction method and apparatus, a device, a storage medium, and a program product, which can implement enhanced viewer engagement through viewer-initiated information promotion requests and livestreamer-controlled content display.

According to some embodiments, a video livestreaming-based interaction method, performed by a computer device, includes: receiving at least one information promotion request from a requesting viewer account associated with a video livestreaming room of a livestreamer account; displaying the at least one information promotion request in a video livestreaming image provided for the livestreamer account; and receiving a promotion confirmation operation selecting a target information promotion request from the at least one information promotion request; displaying target promotion information corresponding to the target information promotion request in the video livestreaming image; and pushing the target promotion information to at least one viewer account associated with a video livestreaming room.

According to some embodiments, a video livestreaming-based interaction apparatus, includes: at least one memory configured to store program code; and at least one processor configured to read the program code and operate as instructed by the program code, the program code including: receiving code configured to cause at least one of the at least one processor to receive at least one information promotion request from a requesting viewer account associated with a video livestreaming room of a livestreamer account; display code configured to cause at least one of the at least one processor to display the at least one information promotion request in a video livestreaming image provided for the livestreamer account; and confirmation code configured to cause at least one of the at least one processor to receive a promotion confirmation operation selecting a target information promotion request from the at least one information promotion request; promotion code configured to cause at least one of the at least one processor to display target promotion information corresponding to the target information promotion request in the video livestreaming image; and pushing code configured to cause at least one of the at least one processor to push the target promotion information to at least one viewer account associated with a video livestreaming room.

According to some embodiments, a non-transitory computer-readable storage medium, storing computer code which, when executed by at least one processor, causes the at least one processor to at least: receive at least one information promotion request from a requesting viewer account associated with a video livestreaming room of a livestreamer account; display the at least one information promotion request in a video livestreaming image provided for the livestreamer account; and receive a promotion confirmation operation selecting a target information promotion request from the at least one information promotion request; display target promotion information corresponding to the target information promotion request in the video livestreaming image; and push the target promotion information to at least one viewer account associated with a video livestreaming room.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a diagram of an application environment of a video livestreaming-based interaction method according to some embodiments.

FIG. 2 is a schematic flowchart of a video livestreaming-based interaction method according to some embodiments.

FIG. 3 is a schematic diagram of an information promotion request region of a viewer terminal according to some embodiments.

FIG. 4 is a schematic diagram of a browse region according to some embodiments.

FIG. 5A is a schematic flowchart of distribution of target promotion information according to some embodiments.

FIG. 5B is a schematic flowchart of display of target promotion information according to some embodiments.

FIG. 6 is a schematic flowchart of video playback according to some embodiments.

FIG. 7A is a schematic diagram of a video playback application region of a viewer terminal according to some embodiments.

FIG. 7B is a schematic diagram of a browse region regarding a video playback application according to some embodiments.

FIG. 8 is a schematic flowchart of video mixing according to some embodiments.

FIG. 9 is a schematic diagram of display of a mixed video according to some embodiments.

FIG. 10A is a schematic flowchart of display of an explanation video and target promotion information according to some embodiments.

FIG. 10B is a schematic flowchart of display of an explanation video and target promotion information according to another embodiment.

FIG. 11 is a schematic diagram of target promotion information according to some embodiments.

FIG. 12 is a schematic flowchart of a video livestreaming-based interaction method according to another embodiment.

FIG. 13 is a schematic flowchart of a video livestreaming-based interaction method according to another embodiment.

FIG. 14 is a schematic flowchart of a video livestreaming-based interaction method according to another embodiment.

FIG. 15 is a schematic flowchart of a video livestreaming-based interaction method according to another embodiment.

FIG. 16 is a structural block diagram of a video livestreaming-based interaction apparatus according to some embodiments.

FIG. 17 is a structural block diagram of a video livestreaming-based interaction apparatus according to another embodiment.

FIG. 18 is a structural block diagram of a video livestreaming-based interaction apparatus according to another embodiment.

FIG. 19 is a structural block diagram of a video livestreaming-based interaction apparatus according to another embodiment.

FIG. 20 is a diagram of an internal structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The technical solutions in embodiments of this application are clearly and completely described in the following with reference to the accompanying drawings in some embodiments. Apparently, the described embodiments are merely some rather than all of some embodiments. All other embodiments obtained by a person of ordinary skill in the art based on some embodiments without creative efforts shall fall within the protection scope of this application.

In a related technology, a promoter wants to promote promotion information to more users. The promoter may display to-be-promoted information or product information in a video livestreaming room of a livestreamer. In this way, traffic of the livestreamer can be acquired, to expand a promotion range. However, in this manner, it is required that an account of the promoter has a capability of activating a livestreaming room or the account of the promoter reaches a particular level. To this end, in the related technology, a single information promotion manner results in poor user experience for video interaction-based users.

Based on this, some embodiments provides a video livestreaming-based interaction method, in which at least one information promotion request is displayed in a video livestreaming image provided for a livestreamer account. The information promotion request is initiated by a viewer account associated with a video livestreaming room associated with the livestreamer account. Before the information promotion request is transmitted, there is no need to consider whether the viewer account has a capability of activating a video livestreaming room, nor an account level of the viewer account. As long as the viewer account enters a video livestreaming room associated with a livestreamer account, the viewer account is associated with the livestreamer account, and the viewer account is allowed to transmit the information promotion request to the livestreamer account. The livestreamer account may display, in the video livestreaming image in response to a promotion confirmation operation on a target information promotion request in the at least one information promotion request, target promotion information that the target information promotion request applies for display. The target promotion information may be pushed to all viewer accounts associated with the video livestreaming room associated with the livestreamer account. In this manner, a user is supported to apply for information promotion in others' video livestreaming rooms by using the user's account, video-based information promotion manners are enriched, promotion information needing to be displayed in a current video livestreaming room can be efficiently determined during the livestreaming, resulting in high efficiency, labor costs caused by implementation of negotiation preparation are reduced, and user experience based on video livestreaming interaction is effectively improved.

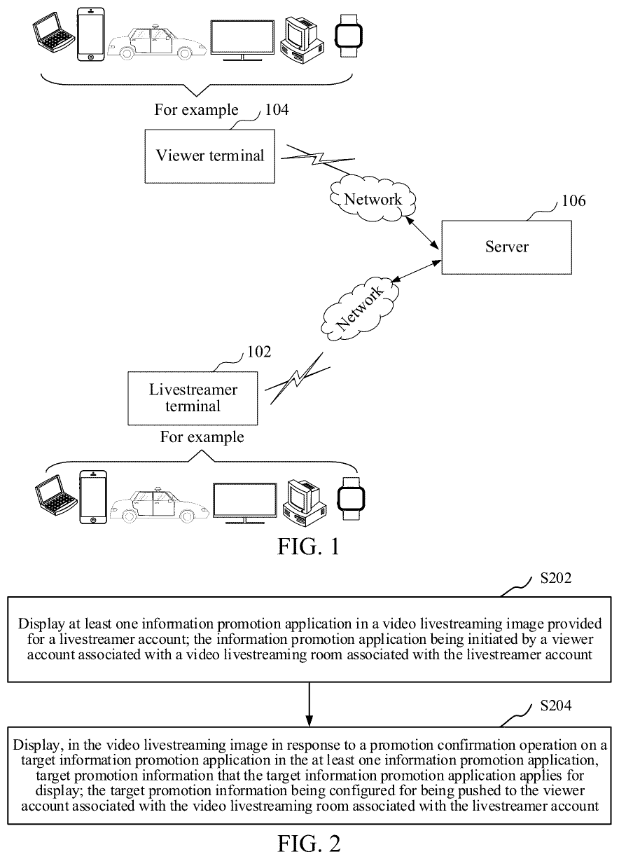

A video livestreaming-based interaction method according to some embodiments may be applied to an application environment shown in FIG. 1. A livestreamer terminal 102 is in communication with a viewer terminal 104 over a network. The livestreamer terminal is a terminal logged in with a livestreamer account, and the viewer terminal is a terminal logged in with a viewer account. The livestreamer terminal 102 and the viewer terminal 104 are both loaded with a target application program having a video livestreaming function. For example, the target application program may be an interactive application program, and a video livestreaming room for interaction can be activated based on the interactive application program.

In some embodiments, the target application program is logged into with a livestreamer account on the livestreamer terminal 102. The livestreamer terminal 102 displays at least one information promotion request in a video livestreaming image provided for the livestreamer account. The information promotion request is initiated by the viewer terminal 104. The viewer terminal 104 is a terminal in which a viewer account associated with a video livestreaming room associated with the livestreamer account is located. The livestreamer terminal 102 displays, in the video livestreaming image in response to a promotion confirmation operation on a target information promotion request in the at least one information promotion request, target promotion information that the target information promotion request applies for display. The target promotion information is configured for being pushed to the viewer account associated with the video livestreaming room associated with the livestreamer account.

In some embodiments, the livestreamer terminal 102 and the viewer terminal 104 respectively communicate with a server 106 by using a network. For example, the target application program is logged into with a livestreamer account on the livestreamer terminal 102, and the target application program is logged into with a viewer account on the viewer terminal 104. After the livestreamer terminal 102 activates the video livestreaming room associated with the livestreamer account and the viewer account enters the video livestreaming room associated with the livestreamer account, it may be considered that the viewer account is associated with the video livestreaming room associated with the livestreamer account. The server 106 acquires a video livestreaming image regarding the livestreamer account and transmitted by the livestreamer terminal 102, and distributes the received video livestreaming image to the viewer terminal 104, so that the viewer terminal 104 displays the video livestreaming image of the livestreamer account.

Each viewer terminal 104 transmits at least one promotion information application to the server 106 by using a respective viewer account, the server 106 transmits the at least one promotion information application to the livestreamer terminal 102, and the livestreamer terminal 102 displays the received information promotion request. The livestreamer terminal 102 displays, in the video livestreaming image in response to a promotion confirmation operation on a target information promotion request in all the information promotion requests, target promotion information that the target information promotion request applies for display.

Both the livestreamer terminal 102 and the viewer terminal 104 are terminals. The terminals may be, but are not limited to, various personal computers, notebook computers, smart phones, tablet computers, Internet of Things devices, portable wearable devices, vehicle-mounted terminals, aircrafts, or the like. The Internet of Things devices may be smart speakers, smart televisions, intelligent vehicle-mounted devices, intelligent voice interaction devices, intelligent appliances, or the like. The portable wearable devices may be smart watches, smart bracelets, or the like. The server 106 may be implemented by using a standalone server or a server cluster that includes a plurality of servers. A data storage system may store data needing to be processed by the server. The data storage system may be integrated on the server, or placed on a cloud or another server. Some embodiments may be applied to various scenarios, including, but not limited to, a cloud technology, artificial intelligence, intelligent transportation, assisted driving, and the like.

In some embodiments, as shown in FIG. 2, a video livestreaming-based interaction method is provided. For example, the method is applied to the livestreamer terminal 102 in FIG. 1, and includes the following operations:

Operation S202: Display at least one information promotion request in a video livestreaming image provided for a livestreamer account; the information promotion request being initiated by a viewer account associated with a video livestreaming room associated with the livestreamer account.

The video livestreaming room is a virtual space created by the livestreamer account. The video livestreaming room is configured for displaying content uploaded by using the livestreamer account. The content may be content locally uploaded from the livestreamer terminal, or may be captured in real time by activating a camera device of the livestreamer terminal. The content may be audio and video content of the livestreamer, for example, what the livestreamer is doing and what the livestreamer is saying, or may be multimedia content played back by the livestreamer, for example, music or a movie played back. The video livestreaming image is an image displayed to all users entering the video livestreaming room. The livestreamer account is an account having permission to activate the video livestreaming room.

After a livestreamer activates the video livestreaming room by using the livestreamer account, the viewer account connected to the video livestreaming room is determined as an account associated with the video livestreaming room associated with the livestreamer account. In this case, content displayed in the video livestreaming room is viewable by all viewers entering the video livestreaming room. The viewer account may be an account having permission to activate the video livestreaming room, or may be an account having no permission to activate the video livestreaming room, which is not limited.

The information promotion request is information configured for applying for displaying promotion information in the video livestreaming room, and may be configured for displaying promotion information transmitted by the viewer account associated with the video livestreaming room. The promotion information is information about a promotion object, and the promotion information may be in a text form, a picture form, a combination form of text and a picture, or the like. The promotion object may be a to-be-promoted physical item, for example, calligraphy, paintings, food, or clothes, or may be a virtual item, for example, a virtual game or a virtual avatar-related product. The information promotion request is an application initiated by the viewer account. Each information promotion request corresponds to a piece of promotion information, and each piece of promotion information is configured for promoting a piece of content. For example, the livestreamer terminal receives two information promotion requests from a viewer account, which are respectively an information promotion request A1 and an information promotion request A2. The information promotion request A1 is configured for applying for displaying promotion information M1 in the video livestreaming image of the livestreamer account. The promotion information M1 is configured for promoting a kind of food. The information promotion request A2 is configured for applying for displaying promotion information M2 in the video livestreaming image of the livestreamer account. The promotion information M2 is configured for promoting an accessory.

In some embodiments, the livestreamer terminal activates the video livestreaming room initiated by the livestreamer account, and displays the video livestreaming image provided for the livestreamer account. After acquiring the at least one information promotion request, the livestreamer terminal displays the at least one information promotion request in the video livestreaming image.

For example, after prompt information of the information promotion request is displayed in the video livestreaming image, the livestreamer terminal may respond to a trigger operation on the prompt information of the information promotion request, and the livestreamer terminal displays an information promotion request list. The information promotion request list includes a plurality of information promotion request sublists initiated by at least one viewer account associated with the video livestreaming room associated with the livestreamer account. Each information promotion request sublist includes at least one information promotion request initiated by a same viewer account.

Operation S204: Display, in the video livestreaming image in response to a promotion confirmation operation on a target information promotion request in the at least one information promotion request, target promotion information that the target information promotion request applies for display; the target promotion information being configured for being pushed to the viewer account associated with the video livestreaming room associated with the livestreamer account.

The target information promotion request is an information promotion request confirmed by the livestreamer terminal, and the promotion confirmation operation is an operation of allowing the viewer account to perform promotion in the video livestreaming room associated with the livestreamer account. The target promotion information may be displayed in a form of a picture or text in the video livestreaming image. The target promotion information includes detailed information of the promotion object, for example, a name and attribute information of the promotion object.

In some embodiments, in response to the promotion confirmation operation on the target information promotion request in the at least one information promotion request, the livestreamer terminal acquires the target promotion information corresponding to the target information promotion request transmitted by the viewer terminal. The livestreamer terminal displays the target promotion information in an overlaid manner in the video livestreaming image. For example, in response to a promotion confirmation operation on at least one target information promotion request that is initiated by a same viewer account and in a plurality of information promotion requests, the livestreamer terminal transmits, to a server, a promotion confirmation reply to the at least one target information promotion request confirmed for promotion. The server forwards the promotion confirmation reply to the viewer terminal in which the viewer account is located. The viewer may determine, from at least one piece of target promotion information corresponding to the at least one target information promotion request, one or some or all of the target promotion information as promotion information to be displayed in the video livestreaming image of the livestreamer account, and transmit selected target promotion information to the server to forward the selected target promotion information to the livestreamer terminal. The livestreamer terminal displays, in the video livestreaming image, the target promotion information selected by the viewer. Certainly, the server also simultaneously forwards the target promotion information selected by the viewer to all viewer terminals connected to the video livestreaming room, so that all the viewers in the video livestreaming room see the selected target promotion information in respective viewer terminals.

In some other examples, in response to promotion confirmation operations on target promotion information respectively initiated by different viewers in a plurality of information promotion requests, the livestreamer terminal transmits, to the server, confirmation replies to the plurality of target information promotion requests confirmed for promotion.

In this example, there are a plurality of promotion positions in the video livestreaming image of the livestreamer terminal. Promotion objects associated with the livestreamer or promotion objects associated with the viewer may be promoted at the promotion positions. In this case, the livestreamer terminal may receive target information promotion requests of a plurality of viewer accounts. For example, target promotion applications 1 to 3 are initiated by a viewer account A, and target promotion applications 3 to 5 are initiated by a viewer account B.

Therefore, continuing the example, the server transmits a confirmation reply to each target information promotion request to the viewer terminal in which the corresponding viewer account is located. Each viewer terminal that receives the target information promotion request transmits target promotion information corresponding to the target information promotion request to the server, and the server transmit the target promotion information to the livestreamer terminal. The livestreamer terminal displays, in the video livestreaming image, a plurality of pieces of target promotion information received.

In the foregoing video livestreaming-based interaction method, at least one information promotion request is displayed in a video livestreaming image provided for a livestreamer account. The information promotion request is initiated by a viewer account associated with a video livestreaming room associated with the livestreamer account. Before the information promotion request is transmitted, there is no need to consider whether the viewer account has a capability of activating a video livestreaming room, nor an account level of the viewer account. As long as the viewer account enters a video livestreaming room associated with a livestreamer account, the viewer account is associated with the livestreamer account, and the viewer account is allowed to transmit the information promotion request to the livestreamer account. The livestreamer account may display, in the video livestreaming image in response to a promotion confirmation operation on a target information promotion request in the at least one information promotion request, target promotion information that the target information promotion request applies for display. The target promotion information may be pushed to all viewer accounts associated with the video livestreaming room associated with the livestreamer account. In this manner, a user is supported to apply for information promotion in others' video livestreaming rooms by using the user's account, video-based information promotion manners are enriched, promotion information needing to be displayed in a current video livestreaming room can be efficiently determined during the livestreaming, resulting in high efficiency, labor costs caused by implementation of negotiation preparation are reduced, and user experience based on video interaction is effectively improved.

In some embodiments, before the displaying at least one information promotion request in a video livestreaming image provided for a livestreamer account, the method further includes: receiving an information promotion request initiated by the viewer account associated with the video livestreaming room associated with the livestreamer account, the information promotion request including promotion information of a promotion object; and generating the information promotion request according to the information promotion request.

The information promotion request is a request transmitted to the livestreamer terminal by the viewer terminal in which the viewer account is located. The information promotion request is configured for requesting displaying promotion information from the viewer account in the video livestreaming room associated with the livestreamer account. As mentioned above, the promotion information is information about a promotion object, and the promotion information may be a promotion animated image, a promotion picture, promotion text, or a purchase link of the promotion object.

In some embodiments, the livestreamer terminal receives an information promotion request list transmitted by at least one viewer terminal, and generates, based on the information promotion request list transmitted by the at least one viewer terminal, an information promotion request sublist corresponding to the viewer terminal. The information promotion request sublist includes at least one information promotion request initiated by a viewer account logged in on the viewer terminal. The livestreamer terminal integrates the information promotion request sublist corresponding to the at least one viewer terminal, to obtain an information promotion request list, and displays the information promotion request list. The information promotion request list includes at least one information promotion request.

For example, if the livestreamer terminal receives information promotion request lists transmitted by a plurality of viewer terminals, the information promotion request list of each viewer terminal includes at least one information promotion request. For each information promotion request, the livestreamer terminal generates, according to promotion information in the information promotion information request, an information promotion request including the promotion information. The livestreamer terminal displays, in the video livestreaming image provided for the livestreamer account, the at least one information promotion request corresponding to each viewer terminal.

If the livestreamer terminal receives at least one information promotion request transmitted by a viewer terminal, the livestreamer terminal generates an information promotion request corresponding to each information promotion request according to promotion information in each information promotion request, and displays at least one information promotion request in the video livestreaming image provided for the livestreamer account.

In some embodiments, an information promotion request initiated by the viewer account associated with the video livestreaming room associated with the livestreamer account is received, where the information promotion request includes promotion information of a promotion object, and an information promotion request that can be displayed is generated according to the information promotion request. In this way, as long as a viewer account enters the video livestreaming room, an information promotion request can be initiated, to display a corresponding information promotion request in the video livestreaming image. In this way, the livestreamer account may subsequently display, in the video livestreaming image in response to a promotion confirmation operation on a target information promotion request in the at least one information promotion request, target promotion information that the target information promotion request applies for display. In this way, video-based information promotion manners are enriched, promotion information needing to be displayed in a current video livestreaming room can be efficiently determined during the livestreaming, resulting in high efficiency, labor costs caused by implementation of negotiation preparation are reduced, and user experience based on video interaction is effectively improved.

In some embodiments, the information promotion request further includes at least one of the viewer account initiating the corresponding information promotion request, a promotion duration, and a quantity of virtual resources.

The promotion duration is a duration during which the promotion information corresponding to the information promotion request is displayed in the video livestreaming room. The virtual resources are virtual resources deducted from the viewer account to the livestreamer account, and the virtual resources may be virtual gifts. The quantity of virtual resources is a quantity of virtual resources per unit, for example, a quantity of gifts.

Certainly, the information promotion request further includes an account type identifier of the viewer account initiating the corresponding information promotion request. For example, if the account type identifier is a common type identifier, the virtual resource quota may be based on an input by a viewer. If the account type identifier is an uncommon type identifier, the quantity of virtual resources is a preset quantity. An uncommon type refers to a type of virtual resources not needing to be deducted to the livestreamer account. For example, the uncommon type is an agricultural assistance type. In another example, the uncommon type is a public welfare type. In this case, the preset quantity may be a value 0.

In some embodiments, the information promotion request further includes at least one of the viewer account initiating the corresponding information promotion request, a promotion duration, and a quantity of virtual resources. In this way, the information promotion request includes the viewer account, so that the livestreamer account can select promotion information matching the video livestreaming room, and effectively reject display of poor-quality promotion information. The information promotion request includes the promotion duration, so as to facilitate control over a display duration of the promotion information corresponding to the viewer account in the video livestreaming room. The information promotion request includes the quantity of virtual resources, so that manners of information promotion performed by the viewer account can be enriched, and accurate reference data can also be provided for the livestreamer account to confirm the information promotion request, thereby further improving interaction efficiency.

In some embodiments, when the viewer terminal displays the video livestreaming image provided for the livestreamer account, the video livestreaming image includes a video regarding the livestreamer. An information promotion request region regarding the promotion object is displayed in the video livestreaming image. Object information corresponding to each promotion object is displayed in the information promotion request region. The object information includes at least one of a promotion object identifier, a promotion duration, and a quantity of virtual resources.

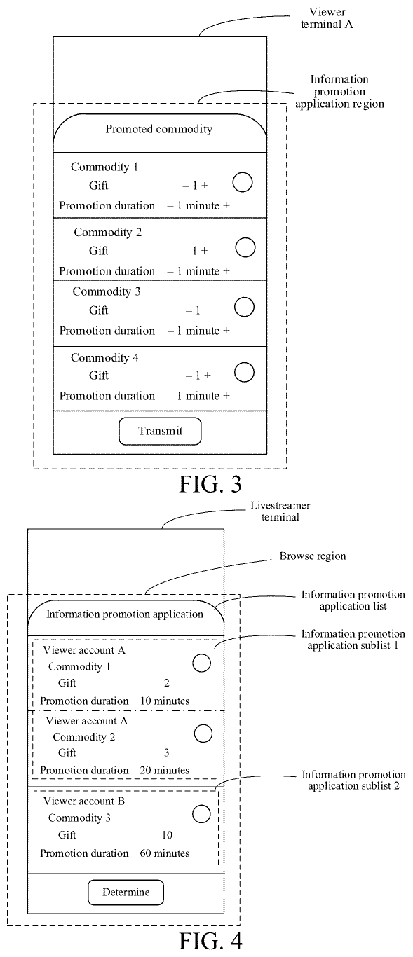

For example, FIG. 3 is a schematic diagram of an information promotion request region of a viewer terminal according to some embodiments. In FIG. 3, a viewer terminal A of a viewer A is used as an example for description. A viewer account of the viewer A is connected to a video livestreaming room associated with a livestreamer account. In this case, a video livestreaming image of the viewer terminal A is shown in FIG. 3. Using a commodity interaction scenario as an example, the information promotion request region includes a list of selected to-be-promoted commodities. Commodity information of 4 commodities associated with the viewer account are displayed in the list, which are respectively commodity information of a commodity 1, a commodity 2, a commodity 3, and a commodity 4. The commodity information includes a quantity of gifts and a promotion duration (1 minute is used as an initial promotion duration). The quantity of gifts corresponds to a quantity selection control. The quantity selection control includes an increase button (“+” in FIG. 3) and a decrease button (“−” in FIG. 3). The viewer account clicks a corresponding button on the quantity selection control, to determine a quantity of virtual resources in an information promotion request corresponding to the commodity. Similarly, the promotion duration corresponds to a duration selection control. The duration selection control includes an increase button (“+” in FIG. 3) and a decrease button (“−” in FIG. 3). The viewer account clicks a corresponding button on the duration selection control, to determine a promotion duration in the information promotion request corresponding to the commodity. The viewer terminal A generates, in response to a transmission control in the information promotion request region, an information promotion request list initiated by the viewer account. The information promotion request list includes an information promotion request of at least one promotion object associated with the viewer account.

In some embodiments, when the viewer terminal displays the video livestreaming image provided for the livestreamer account, the video livestreaming image includes a video regarding the livestreamer. An information promotion request region regarding the promotion object is displayed in the video livestreaming image. Object information corresponding to each promotion object can be displayed in real time in the information promotion request region. The object information includes at least one of a promotion object identifier, a promotion duration, and a quantity of virtual resources. In this way, a corresponding information promotion request can be accurately generated.

In some embodiments, the displaying at least one information promotion request in a video livestreaming image provided for a livestreamer account includes: displaying a browse region regarding the information promotion request in the video livestreaming image provided for the livestreamer account; and displaying application information of each information promotion request in the browse region, the application information including at least one of the viewer account initiating the corresponding information promotion request, a promotion duration, and a quantity of virtual resources.

The browse region is a region used by the livestreamer terminal to display an information promotion request of at least one viewer account.

In some embodiments, when the video regarding the livestreamer is played back in the video livestreaming image, the livestreamer terminal displays the browse region regarding the information promotion request. An information promotion request list is displayed in the browse region. In some embodiments, the information promotion request list includes an information promotion request sublist initiated by at least one viewer account. Each information promotion request sublist includes application information of at least one information promotion request. The application information includes at least one of the viewer account initiating the corresponding information promotion request, a promotion duration, and a quantity of virtual resources. The application information further includes account information of the viewer account initiating the corresponding information promotion request. The account information includes a level, a quantity of times of historical applications, a quantity of times of interactions in the video livestreaming room, and the like. The account information reflects an activity degree of the corresponding viewer account in the video livestreaming room associated with the livestreamer account. A higher level indicates a larger quantity of times of historical applications and a larger quantity of times of interactions, and indicates a higher activity degree.

For example, in the information promotion request list, information promotion request sublists corresponding to respective viewer accounts are displayed according to corresponding sequence numbers based on account information of the viewer accounts. A higher activity degree reflected by the account information indicates a higher corresponding sorting position.

For example, the livestreamer terminal displays, according to times at which the viewer accounts initiate the information promotion request sublists, the information promotion request sublists corresponding to the viewer accounts according to the corresponding sequence numbers. An earlier time indicates a higher corresponding sorting position.

For example, the livestreamer terminal displays, according to a total quantity of virtual resources transmitted by each viewer account to the livestreamer account, the information promotion request sublists corresponding to the viewer accounts according to the corresponding sequence numbers. A larger total quantity indicates a higher corresponding sorting position. For each viewer account, a sum of quantities of virtual resources in the information promotion request sublists corresponding to the viewer accounts is the corresponding total quantity.

For example, the livestreamer terminal displays, according to a total promotion duration that each viewer account applies for, the information promotion request sublists corresponding to the viewer accounts according to the corresponding sequence numbers. A shorter total duration indicates a higher corresponding sorting position. For each viewer account, a sum of promotion durations in the information promotion request sublists corresponding to the viewer accounts is the total promotion duration.

For example, in response to a drag operation on the information promotion request sublists corresponding to the viewer accounts, the livestreamer terminal determines sorting sequence numbers of the information promotion request sublists. For example, the livestreamer may drag the information promotion request sublists in the information promotion request list, and sort the information promotion request sublists in a manner, to facilitate selection by the livestreamer.

FIG. 4 is a schematic diagram of a browse region according to some embodiments. A livestreamer terminal is used as an example for description in FIG. 4. An information promotion request list is displayed in a browse region of the livestreamer terminal. The information promotion request list includes an information promotion request. The information promotion request list in FIG. 4 includes application information of two viewer accounts, which are respectively an information promotion request sublist 1 and an information promotion request sublist 2. Application information initiated by a viewer account A is displayed in the information promotion request sublist 1. The viewer account A applies for promoting two commodities, which are a commodity 1 and a commodity 2 respectively. The commodity 1 has 2 gifts and a promotion duration of 10 minutes. The commodity 2 has 3 gifts and a promotion duration of 20 minutes. Therefore, a total promotion duration of the viewer account A is 30 minutes. Application information initiated by a viewer account B is displayed in the information promotion request sublist 2. The viewer account B applies for promoting 1 commodity, for example, a commodity 3. The commodity 3 has 10 gifts and a promotion duration of 60 minutes.

In some embodiments, the browse region regarding the information promotion request is displayed in the video livestreaming image provided for the livestreamer account; and application information of each information promotion request is displayed in real time in the browse region. The application information includes at least one of the viewer account initiating the corresponding information promotion request, a promotion duration, and a quantity of virtual resources. In this way, based on application information of each information promotion request, the livestreamer may select, by integrating at least one of a viewer account, a promotion duration, and a quantity of virtual resources that bring revenue to the livestreamer, a viewer account matching the video livestreaming room, and allow promotion information of the matching viewer account to be displayed in the video livestreaming room. In this way, manners of information promotion performed by the viewer account can be enriched, and accurate reference data can also be provided for the livestreamer account to confirm the information promotion request, thereby further improving interaction efficiency.

In some embodiments, the displaying a browse region related to the information promotion request in the video livestreaming image provided for the livestreamer account includes: displaying, in response to a trigger operation on a viewing entry of the information promotion request in the video livestreaming image provided for the livestreamer account, the browse region regarding the information promotion request in the video livestreaming image.

For example, after receiving an information promotion request initiated by the viewer terminal, the livestreamer terminal generates an information promotion request based on the information promotion request, and displays an update icon on a viewing entry of the information promotion request. The update icon is configured for reminding the livestreamer to view the information promotion request. The livestreamer terminal displays, in response to a trigger operation on the viewing entry of the information promotion request in the video livestreaming image provided for the livestreamer account, a browse region regarding the information promotion request in the video livestreaming image.

In some embodiments, in response to the trigger operation on the viewing entry of the information promotion request in the video livestreaming image provided for the livestreamer account, the browse region regarding the information promotion request is displayed in real time in the video livestreaming image. In this way, a matching viewer account can be subsequently selected for the video livestreaming room based on the displayed browse region regarding the information promotion request, and promotion information of the matching viewer account is allowed to be displayed in the video livestreaming room. In this way, manners of information promotion performed by the viewer account can be enriched, and accurate reference data can also be provided for the livestreamer account to confirm the information promotion request, thereby further improving interaction efficiency.

In some embodiments, the displaying, in the video livestreaming image in response to a promotion confirmation operation on a target information promotion request in the at least one information promotion request, target promotion information that the target information promotion request applies for display includes: adding, in response to the promotion confirmation operation on the target information promotion request in the at least one information promotion request, the target promotion information that the target information promotion request applies for display to a list of interactive information associated with the video livestreaming room associated with the livestreamer account, the list of interactive information associated with the video livestreaming room being configured for the viewer account associated with the video livestreaming room to trigger an online transaction operation on the interactive information.

The list of interactive information is a list used by each viewer entering the video livestreaming room to initiate an online transaction. For example, the list of interactive information may be understood as a virtual shopping cart, and the list of interactive information includes promotion information of a transaction object associated with the livestreamer account.

In some embodiments, the livestreamer terminal adds, in response to the promotion confirmation operation on the target information promotion request in the at least one information promotion request, the target promotion information that the target information promotion request applies for display to the list of interactive information associated with the video livestreaming room associated with the livestreamer account.

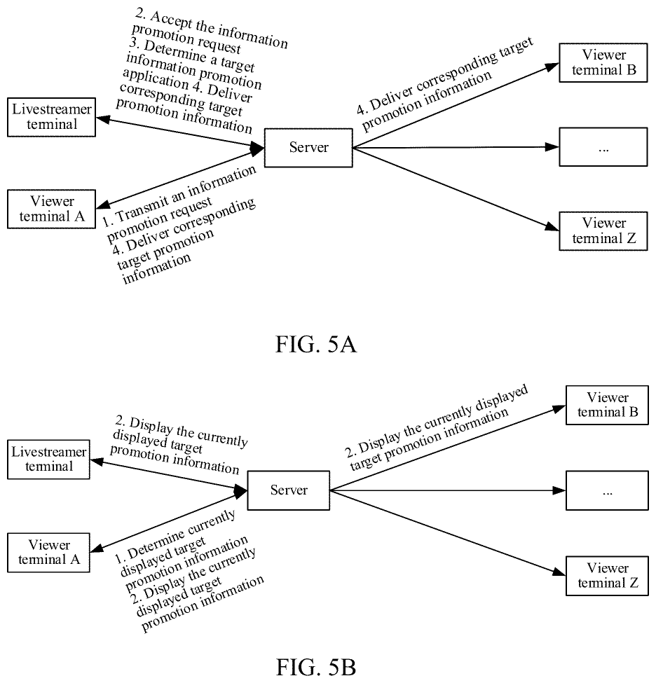

For example, FIG. 5A is a schematic flowchart of distribution of target promotion information according to some embodiments. The video livestreaming room is separately connected to a livestreamer terminal, a viewer terminal A, a viewer terminal B, . . . , and a viewer terminal Z. The viewer terminal A transmits an information promotion request to the server, the livestreamer terminal accepts the information promotion request forwarded by the server, and the livestreamer terminal generates an information promotion request based on the information promotion request. After the livestreamer terminal generates at least one information promotion request based on at least one information promotion request, in response to a promotion confirmation operation of a target information promotion request in the at least one information promotion request, the livestreamer terminal determines the target information promotion request, and delivers corresponding target promotion information to the server. The server forwards the target promotion information to the livestreamer terminal, the viewer terminal A, the viewer terminal B, . . . , and the viewer terminal Z.

For example, if the livestreamer terminal confirms a plurality of pieces of target promotion information, after adding the target promotion information that the target information promotion request applies for display to the list of interactive information associated with the video livestreaming room associated with the livestreamer account, the livestreamer terminal displays the target promotion information in an overlaid manner in the video livestreaming image. The target promotion information may be displayed in a form of small cards in the video livestreaming image.

For example, if the livestreamer terminal confirms a plurality of pieces of target promotion information, after the livestreamer terminal adds the target promotion information that the target information promotion request applies for display to the list of interactive information associated with the video livestreaming room associated with the livestreamer account, the livestreamer terminal transmits the plurality of pieces of target promotion information to the viewer terminal initiating the information promotion request, and the viewer terminal determines selected target promotion information in response to a selection operation on one of the plurality of pieces of target promotion information. The viewer terminal transmits the selected target promotion information to the server, to instruct the server to display the selected target promotion information to all terminals connected to the video livestreaming room. FIG. 5B is a schematic flowchart of display of target promotion information according to some embodiments. The video livestreaming room is separately connected to a livestreamer terminal, a viewer terminal A, a viewer terminal B, . . . , and a viewer terminal Z. After determining selected target promotion information, the viewer terminal A transmits the selected target promotion information to the server, and the server distributes the selected target promotion information to the livestreamer terminal, the viewer terminal A, the viewer terminal B, . . . , and the viewer terminal Z.

In some embodiments, in response to the promotion confirmation operation on the target information promotion request in the at least one information promotion request, the target promotion information that the target information promotion request applies for display is added to a list of interactive information associated with the video livestreaming room associated with the livestreamer account. The list of interactive information associated with the video livestreaming room is configured for the viewer account associated with the video livestreaming room to trigger an online transaction operation on the interactive information. In this way, all viewer accounts associated with the video livestreaming room may perform the online transaction operation on the target promotion information in real time based on the list of interactive information, thereby expanding a promotion range of the target promotion information.

To enable all viewers entering the video livestreaming room to watch the explanation video of the target promotion object indicated by the target promotion information, before initiating the information promotion request, the viewer terminal corresponding to the target promotion information initiates a video playback application. In this way, after the livestreamer terminal confirms the video playback application, the explanation video is displayed in the video livestreaming image.

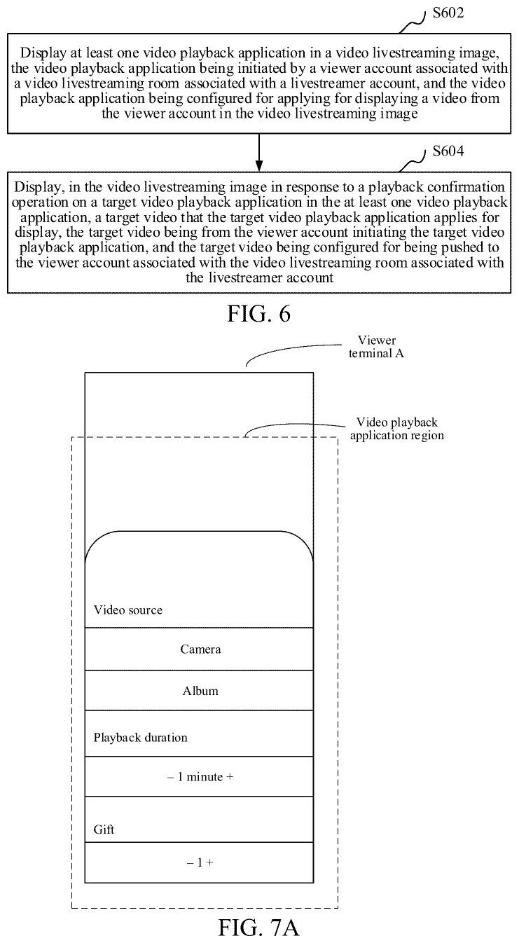

To this end, in some embodiments, FIG. 6 is a schematic flowchart of video playback according to some embodiments. The method further includes the following operations:

Operation S602: Display at least one video playback application in a video livestreaming image, the video playback application being initiated by a viewer account associated with a video livestreaming room associated with a livestreamer account, and the video playback application being configured for applying for displaying a video from the viewer account in the video livestreaming image.

In some embodiments, when the livestreamer terminal displays the video livestreaming image provided for the livestreamer account, the livestreamer terminal displays a video playback application initiated by at least one viewer account. Each viewer account corresponds to one video playback application.

For example, for each viewer account connected to the video livestreaming room, if the viewer account has a promotion requirement, when a viewer terminal in which the viewer account is located displays a video livestreaming image provided for the livestreamer account, the viewer terminal initiates a video playback request to the livestreamer terminal in response to a trigger operation on a video playback control in the video livestreaming image. The livestreamer terminal receives the video playback request initiated by the viewer account from the viewer terminal, and generates the video playback application according to the video playback request.

The video playback control is configured to trigger acquisition of the video playback request.

Operation S604: Display, in the video livestreaming image in response to a playback confirmation operation on a target video playback application in the at least one video playback application, a target video that the target video playback application applies for display, the target video being from the viewer account initiating the target video playback application, and the target video being configured for being pushed to the viewer account associated with the video livestreaming room associated with the livestreamer account.

The target video is a video regarding a viewer account initiating a corresponding target video playback application. The video may be an explanation video of a promotion object associated with the viewer account, or may be a video of a viewer corresponding to the viewer account, which is not limited.

In some embodiments, the livestreamer terminal acquires, in response to the playback confirmation operation on the target video playback application in the at least one video playback application, a target video transmitted by the viewer account initiating the target video playback application, and displays the target video in a viewer video region in the video livestreaming image. The viewer video region may be an entire region of the video livestreaming image, or may be a partial region of the video livestreaming image, which is not limited.

For example, in response to the playback confirmation operation on the target video playback application in the at least one video playback application, the livestreamer terminal transmits, to the server, information allowing an information promotion control to be displayed. The information includes an identifier of a viewer terminal that allows the information promotion control to be displayed. The server transmits the information allowing the information promotion control to be displayed to a viewer terminal corresponding to the identifier. After receiving the information allowing the information promotion control to be displayed, the viewer terminal displays the information promotion control in a video livestreaming image of the viewer terminal. The information promotion control is configured to trigger the viewer terminal to generate an information promotion request.

Based on this, the viewer terminal initiates an information promotion request to the livestreamer account in response to a trigger operation on the information promotion control, and after receiving the information promotion request, the livestreamer terminal in which the livestreamer account is located generates a corresponding information promotion request. After receiving the at least one information promotion request, the livestreamer terminal performs operation S202. For example, in a process in which the target video is displayed in the video livestreaming image, at least one piece of target promotion information is displayed in the video livestreaming image. For example, the promotion object corresponding to the at least one piece of target promotion information may be explained in the target video.

In some embodiments, at least one video playback application is displayed in a video livestreaming image provided for a livestreamer account, the video playback application is initiated by a viewer account associated with a video livestreaming room associated with the livestreamer account, and the video playback application is configured for applying for displaying a video from the viewer account in the video livestreaming image. Before the video playback application is transmitted, there is no need to consider whether the viewer account has a capability of activating a video livestreaming room, nor an account level of the viewer account. As long as the viewer account enters a video livestreaming room associated with a livestreamer account, the viewer account is associated with the livestreamer account, and the viewer account is allowed to transmit the video playback application to the livestreamer account. The livestreamer account may display, in the video livestreaming image in response to a playback confirmation operation on a target video playback application in the at least one video playback application, a target video that the target video playback application applies for display. The target video is from the viewer account initiating the target video playback application. The target video may be pushed to all viewer accounts associated with the video livestreaming room associated with the livestreamer account. In this manner, the user is supported to apply for playing back an uploaded video in others' video livestreaming rooms by using the user's account, video playback manners are enriched, promotion information needing to be displayed in a current video livestreaming room can be efficiently determined during the livestreaming, resulting in high efficiency, labor costs caused by implementation of negotiation preparation are reduced, and user experience based on video interaction is effectively improved.

In some embodiments, before the displaying at least one video playback application in the video livestreaming image, the method further includes: receiving a video playback request initiated by the viewer account associated with the video livestreaming room associated with the livestreamer account, the video playback request including a video source type and a playback duration of a to-be-played-back video; where the video source type includes one of a local video and a captured video; and generating the video playback application according to the video playback request.

In some embodiments, if receiving a video playback request transmitted by a viewer terminal, the livestreamer terminal generates a video playback application according to the video playback request, and displays the video playback application in the video livestreaming image provided for the livestreamer account. The video playback application includes a video source type and a playback duration of a to-be-played-back video.

In some embodiments, if the livestreamer terminal receives video playback requests respectively transmitted by a plurality of viewer terminals, for each video playback request, a corresponding video playback application is generated according to the video playback request. The livestreamer terminal summarizes the video playback applications into a video playback application list, and displays the video playback application list in the video livestreaming image.

For example, after determining the video playback applications, the livestreamer terminal sorts the video playback applications based on playback durations in the video playback applications. A shorter playback duration indicates a higher sorting position of a corresponding video playback application. The livestreamer terminal displays the video playback applications in the video playback application list according to sorting sequence numbers of the video playback applications.

In some embodiments, a video playback request initiated by the viewer account associated with the video livestreaming room associated with the livestreamer account is received. The video playback request includes a video source type and a playback duration of a to-be-played-back video. The video source type includes one of a local video and a captured video. The video playback application is generated according to the video playback request. The video playback application is subsequently displayed in the video livestreaming room. In this manner, the user is supported to apply for playing back an uploaded video in others' video livestreaming rooms by using the user's account, video playback manners are enriched, promotion information needing to be displayed in a current video livestreaming room can be efficiently determined during the livestreaming, resulting in high efficiency, labor costs caused by implementation of negotiation preparation are reduced, and user experience based on video interaction is effectively improved.

In some embodiments, when the video source type is a local video of the viewer terminal initiating the video playback request, the video playback request further includes the local video of the viewer terminal, a viewer account initiating the video playback request, and a quantity of virtual resources. When the video source type is a captured video of the viewer terminal initiating the video playback request, the video playback request further includes a viewer account initiating the video playback request and a quantity of virtual resources.

For example, the video playback request further includes an account type identifier of the viewer account initiating the video playback request. If the account type identifier is the common type identifier mentioned above, the quantity of virtual resources may be based on an input by a viewer. If the account type identifier is the uncommon type identifier described above, the quantity of virtual resources is a preset quantity. For example, the preset quantity is a value 0. In this case, promotion information is subsequently displayed for the uncommon-type viewer account, and the corresponding quantity of virtual resources is also the preset quantity.

In some embodiments, the video playback request includes the viewer account initiating the video playback request, so that it is convenient for the livestreamer to select a viewer account not match the video livestreaming room, thereby preventing playback of an inappropriate video in the video livestreaming room. The video playback request includes the quantity of virtual resources, enabling traffic sales for the livestreamer. For example, the livestreamer is paid to play back a video from a viewer account in the video livestreaming room of the livestreamer.

In some embodiments, when the viewer terminal displays the video livestreaming image provided for the livestreamer account, the video livestreaming image includes a video regarding the livestreamer. The viewer terminal is a terminal in which the video playback request is initiated. A video playback application region regarding video playback is displayed in the video livestreaming image. A viewer account initiating the video playback request on the viewer terminal and a quantity of virtual resources are displayed in the video playback application region.

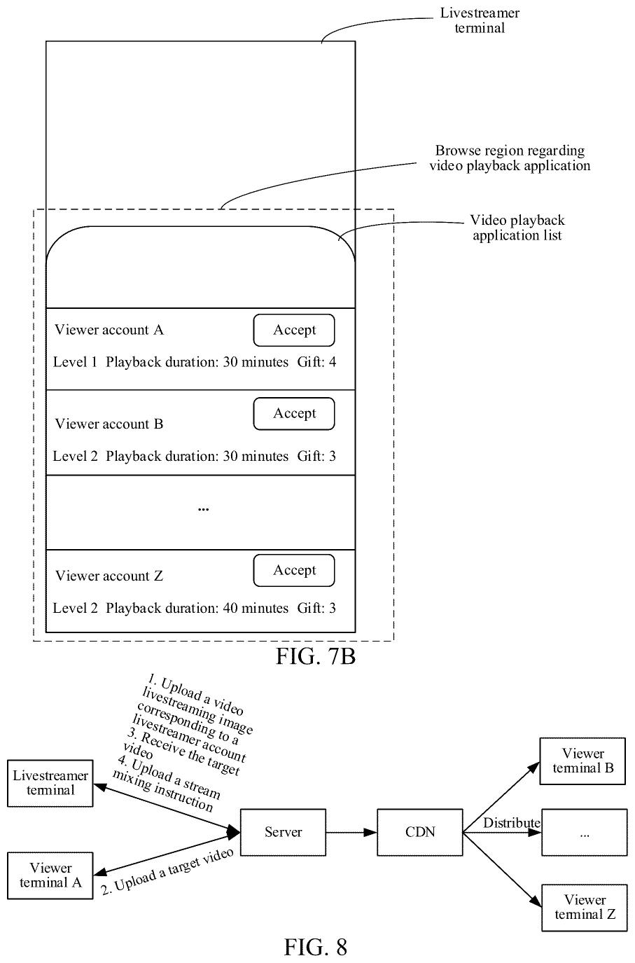

For example, FIG. 7A is a schematic diagram of a video playback application region of a viewer terminal according to some embodiments. In FIG. 7A, a viewer terminal A of a viewer A is used as an example for description. A viewer account of the viewer A is connected to the video livestreaming room associated with the livestreamer account, and related information of a video playback request is displayed in the video playback application region. The video playback request includes a video source type, a playback duration (1 minute is used as an initial promotion duration), and a quantity of virtual resources. FIG. 7A shows options of video sources. One option is a camera, corresponding to the video source type of captured video. The other option is an album, corresponding to the video source type of local video. A playback duration selection control is further displayed. The playback duration selection control includes an increase button (“+” in FIG. 7A) and a decrease button (“−” in FIG. 7A). A quantity selection control of a quantity of gifts is further displayed. The quantity selection control includes an increase button (“+” in FIG. 7A) and a decrease button (“−” in FIG. 7A). The viewer account determines a quantity of virtual resources in a corresponding video playback request by clicking a corresponding button on the quantity selection control.

In some embodiments, when the viewer terminal displays the video livestreaming image provided for the livestreamer account, the video livestreaming image includes a video regarding the livestreamer. The viewer terminal is a terminal in which the video playback request is initiated. A video playback application region regarding video playback is displayed in the video livestreaming image. A viewer account initiating the video playback request on the viewer terminal and a quantity of virtual resources can be displayed in real time in the video playback application region. In this way, the video playback application can be accurately generated.

In some embodiments, the displaying at least one video playback application in the video livestreaming image includes: displaying a browse region regarding the video playback application in the video livestreaming image provided for the livestreamer account, and displaying application information of each information video playback application in the browse region regarding the video playback application, the application information including at least one of the viewer account initiating the corresponding video playback application, a video playback duration, and a quantity of virtual resources.

For example, the application information of the video playback application further includes a level of the viewer account initiating the corresponding video playback application. FIG. 7B is a schematic diagram of a browse region regarding a video playback application according to some embodiments. In FIG. 7B, a livestreamer terminal is used as an example for description. In a traffic region regarding the video playback application, a video playback application list is displayed. A plurality of video playback applications, i.e., a video playback application corresponding to a viewer account A, a video playback application corresponding to a viewer account B, . . . , and a video playback application corresponding to a viewer account Z, are displayed in the video playback application list. For the viewer account A, the video playback application includes a corresponding level (for example, level 1), a playback duration of 30 minutes, and a gift quantity of 4. For the viewer account B, the video playback application includes a corresponding level (for example, level 2), a playback duration of 30 minutes, and a gift quantity of 3. For the viewer account Z, the video playback application includes a corresponding level (for example, level 2), a playback duration of 40 minutes, and a gift quantity of 3. Each video playback application has an accept control. In response to a selection operation on an accept control of a video playback application, the livestreamer terminal determines the video playback application corresponding to the selection operation as a target video playback application.

Based on this, for example, a video playback application initiated by the viewer account A is selected. In this case, if the viewer account A has a promotion requirement, refer to FIG. 3 for an information promotion request region of a viewer terminal in which the viewer account A is located. In this case, a promotion duration of each commodity may not be displayed in FIG. 3. In this case, a sum of promotion durations of promotion objects is less than or equal to a playback duration set by the viewer account. For example, a sum of promotion durations of 4 commodities in FIG. 3 does not exceed 30 minutes in FIG. 7A. In response to a trigger operation on a transmission control in the information promotion request region, the viewer terminal in which the viewer account A is located transmits 4 information promotion requests associated with the viewer account A to the livestreamer terminal. In this case, refer to FIG. 4 for a browse region of the livestreamer terminal. However, in some embodiments, since the livestreamer terminal has selected a viewer account of video playback, for example, the viewer account A in this example, in this case, only an information promotion request sublist of viewer accounts allowing video playback is displayed in the browse region. For example, only the information promotion request sublist of the viewer accounts allowing video playback is displayed in the information promotion request list. If a viewer account A allowing video playback is selected herein, only an information promotion request of the viewer account A is displayed in the browse region. In this case, the promotion duration may not be displayed in the browse region.

In some embodiments, a browse region regarding the video playback application is displayed in the video livestreaming image provided for the livestreamer account, and application information of each information video playback application is displayed in the browse region regarding the video playback application. The application information includes at least one of the viewer account initiating the corresponding video playback application, a video playback duration, and a quantity of virtual resources. In this way, the livestreamer can select, by integrating at least one of a viewer account, a video playback duration, and a quantity of virtual resources that bring revenue to the livestreamer, a viewer account matching the video livestreaming room, and allow the matching viewer account to display an own video in the video livestreaming room. In this way, manners of video playback for the viewer account can be enriched, and accurate reference data can also be provided for the livestreamer account to confirm the information promotion request, thereby further improving interaction efficiency.

In some embodiments, the displaying, in the video livestreaming image in response to a playback confirmation operation on a target video playback application in the at least one video playback application, a target video that the target video playback application applies for display includes: performing, in response to the playback confirmation operation on the target video playback application in the at least one video playback application, same-screen display on the video livestreaming image and the target video that the target video playback application of the viewer account applies for display.

The same-screen display means that the video livestreaming image and the target video are displayed on one screen. The screen is a screen of any terminal in the video livestreaming room, and the terminal includes a livestreamer terminal and a viewer terminal connected to the video livestreaming room.

In some embodiments, the livestreamer terminal responds to the playback confirmation operation on the target video playback application in the at least one video playback application, and the livestreamer terminal acquires a target video transmitted by a viewer terminal corresponding to the target video playback application, and displays the target video in an overlaid manner in the video livestreaming image, to achieve same-screen display on the video livestreaming image and the target video.

For example, after acquiring the target video, the livestreamer terminal determines position parameters of the target video and the video livestreaming image on a screen, and performs same-screen display on the video livestreaming image and the target video based on the position parameters.

In some embodiments, in response to the playback confirmation operation on the target video playback application in the at least one video playback application, same-screen display is directly performed on the video livestreaming image and the target video that the target video playback application of the viewer account applies for display. In this way, all users entering the video livestreaming room may be ensured to watch the video livestreaming image of the livestreamer and the target video of the viewer account initiating the target video playback application, promotion information needing to be displayed in a current video livestreaming room can be efficiently determined during the livestreaming, resulting in high efficiency, labor costs caused by implementation of negotiation preparation are reduced, and user experience based on video interaction is effectively improved.

In some embodiments, the performing same-screen display on the video livestreaming image and the target video that the target video playback application of the viewer account applies for display includes: receiving the target video that the target video playback application of the viewer account applies for display; acquiring an image display parameter regarding the video livestreaming room, the image display parameter being configured for performing same-screen display on the video livestreaming image and the target video; generating a stream mixing instruction based on the image display parameter; transmitting the stream mixing instruction to a server; receiving a mixed video transmitted by the server after performing same-screen mixing on the target video and the video livestreaming image according to the stream mixing instruction; and displaying the mixed video.

In some embodiments, the livestreamer terminal receives the target video that the target video playback application of the viewer account applies for display, and determines an image display parameter of the video livestreaming room. The image display parameter includes position parameters of the video livestreaming room and the target video on a same screen during the same-screen display. The livestreamer terminal generates a stream mixing instruction according to the image display parameter, and transmits the stream mixing instruction to the server. The server mixes the video livestreaming image and the target video according to the stream mixing instruction, to obtain a mixed video, and the livestreamer terminal receives and displays the mixed video.

For example, FIG. 8 is a schematic flowchart of video mixing according to some embodiments. The livestreamer terminal uploads a video livestreaming image corresponding to an own livestreamer account to the server, and the server distributes the video livestreaming image to all terminals in a video livestreaming room, including the livestreamer terminal and all viewer terminals entering the video livestreaming room, by using a content delivery network (CDN). The viewer terminal A corresponding to the target video playback application uploads a target video to the server, and the server transmits the target video to the livestreamer terminal. The livestreamer terminal receives the target video. The livestreamer terminal acquires an image display parameter between video livestreamers, and generates a stream mixing instruction based on the image display parameter. The livestreamer terminal uploads the stream mixing instruction to the server. The server transmits a mixed video after performing same-screen mixing on the target video and the video livestreaming image according to the stream mixing instruction, and distributes the mixed video to the viewer terminal A, the livestreamer terminal, the viewer terminal B, . . . , and the viewer terminal Z by using the CDN.

In the related technology, the livestreamer terminal uploads captured audio and video information of the livestreamer to the server, and the server respectively transmits, by using the CDN, the audio and video information of the livestreamer to all terminals in the video livestreaming room associated with the livestreamer account. Compared with the related technology, in some embodiments, the target video of the viewer terminal can be displayed in the video livestreaming image, thereby improving video interaction efficiency.

For example, parameter information of the image display parameter is shown in Table 1:

TABLE 1
Parameter information of image display parameter

| | Starting | | Z-axis | Whether |
|---|---|---|---|---|
| Number | coordinates | Image size | layer | to mute |
| 123 | x1, y1 | Width 1, | 0 | Yes |
| | | height 1 | | |
| 456 | x2, y2 | Width 2, | 1 | No |
| | | height 2 | | |

The number 123 in Table 1 indicates a video livestreaming image, starting coordinates on the screen are (x1, y1), and a size of the video livestreaming image is (width 1, height 1). If the Z-axis level of the video livestreaming image is 0, the video livestreaming image is at the bottom layer, and the video livestreaming image is muted. The number 456 in Table 1 indicates a target video, starting coordinates on the screen are (x2, y2), and a size of the video livestreaming image is (width 2, height 2). If the Z-axis level of the video livestreaming image is 1, the video livestreaming image is not at the bottom layer, and the video livestreaming image is not muted.

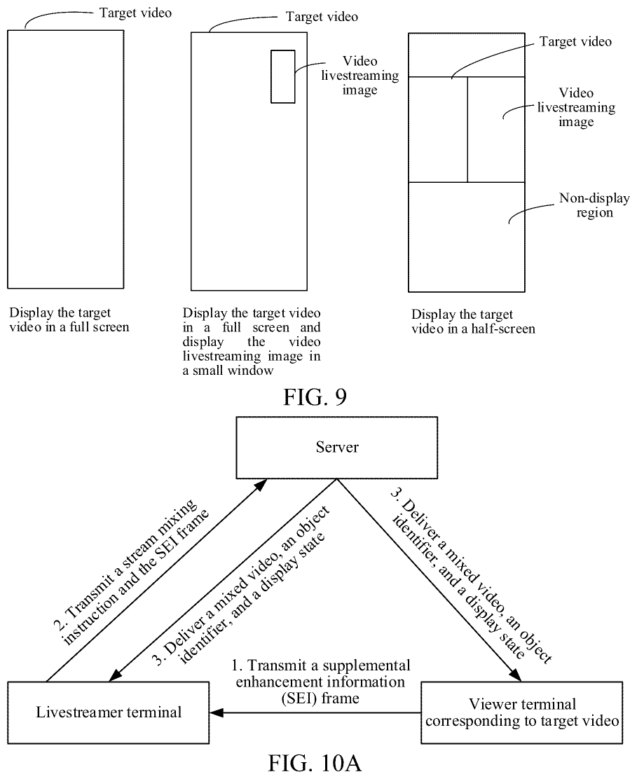

Based on the parameter information in Table 1, the starting coordinates and the image size in the parameter information determine respective display regions of the video livestreaming image and the target video on the screen. FIG. 9 is a schematic diagram of display of a mixed video according to some embodiments. Three display examples are provided in FIG. 9. In Example 1, the target video is displayed in a full screen, only the target video is displayed on the screen, and the video livestreaming image is in a hidden state, for example, is not displayed on the screen. In Example 2, the target video is displayed in a full screen and the video livestreaming image is displayed in a small window. In this case, the target video and the video livestreaming image are displayed on the screen at the same time, and a display area of the video livestreaming image is smaller than that of the target video. In Example 3, the target video is displayed on a half-screen. In this case, a non-display region has a black background, the screen is a display region, the target video is displayed on a half-screen, and the video livestreaming image is displayed on a half-screen.

In some embodiments, the stream mixing instruction for same-screen display can be determined by receiving the target video that the target video playback application applies for display and acquiring the image display parameter. The stream mixing instruction is transmitted to the server. A mixed video transmitted by the server after performing same-screen mixing on the target video and the video livestreaming image according to the stream mixing instruction is received. The mixed video is displayed. In this way, same-screen display can be performed on the video livestreaming image and the target video in terminals entering the video livestreaming room.

In some embodiments, the displaying, in the video livestreaming image, a target video that the target video playback application applies for display includes: displaying, in the video livestreaming image in a process of displaying, in the video livestreaming image, target promotion information that the target information promotion request applies for display, a real-time captured explanation video regarding a target promotion object indicated by the target promotion information.

In some embodiments, in the process of displaying the target promotion information in the video livestreaming image, the real-time captured explanation video regarding the target promotion object is displayed in the video livestreaming image. The explanation video may be a video explained by a viewer of the viewer account initiating the target information promotion request. Certainly, the explanation video may alternatively be a video in which an explainer not entering the video livestreaming room explains to the target promotion object.

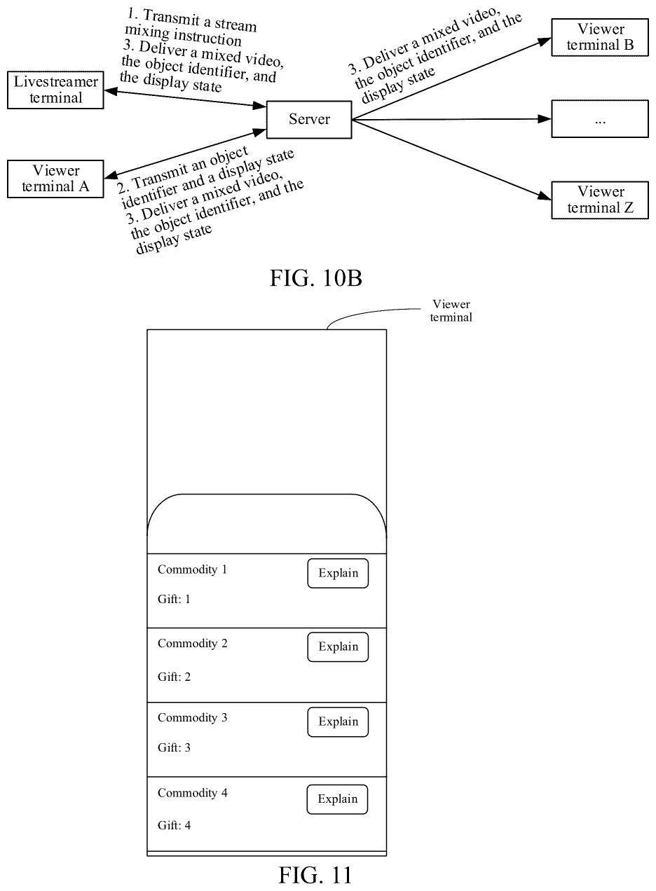

For example, FIG. 10A is a schematic flowchart of display of an explanation video and target promotion information according to some embodiments. After the livestreamer terminal responds to the promotion confirmation operation of the target information promotion request in the at least one information promotion request, first, the viewer terminal corresponding to the target video transmits a video frame and a supplemental enhancement information (SEI) frame of an explanation video of a corresponding target promotion object to the livestreamer terminal. The SEI frame includes an object identifier of the target promotion object and a display state of the target promotion information. Whether the target promotion information is in a display state or a hidden state in the video livestreaming image is determined based on the display state. The livestreamer terminal extracts the SEI frame, generates a stream mixing instruction based on the video frame of the explanation video and a video frame of the video livestreaming image, and transmits the stream mixing instruction and the SEI frame to the server. The server mixes the video frame of the explanation video with the video frame of the video livestreaming image according to the stream mixing instruction, to obtain a mixed video. The mixed video is a video obtained after the explanation video is displayed in an overlaid manner in the video livestreaming image. The mixed video, the object identifier, and the display state are distributed to the terminals, to instruct the terminals to display the mixed video and display the target promotion information according to the object identifier and the display state.

In the foregoing examples, the SEI frame is a SEI frame in a video bitstream. The SEI frame may carry some video-unrelated supplemental information, such as content description and additional data, which are transmitted together with the video content, so transmitted information is synchronized with video content. During video coding, a video is coded into a plurality of macroblocks, and the macroblocks are segmented into a plurality of network abstraction layer units (NALUs, which are data units satisfying network transmission in the video coding). The SEI frame is to encapsulate some supplemental information into a type of NALUs and insert the NALUs into a bitstream. As shown in Table 2 below:

TABLE 2
Format table of NALU bitstream

| | | NALU |
|---|---|---|
| Start code | NALU header | payload |
| 0x 00 00 00 01 | 0x06: SEI frame | . . . |
| | 0x21/0x61: P frame | |
| | 0x25/0x65: I frame | |
| | . . . | |

A format of the NALU bitstream includes a start code, a NALU header, and a NALU payload. In Table 2, the start code of the NALU stream is 0x00000001, and the NALU header includes header data of each frame. For example, the header data of the SEI frame is 0x06, and the header data of the P frame may be 0x21 or 0x61. The header data of the I frame may be 0x25 or 0x65. Both the P frame and the I frame are video frames. The NALU payload is populated according to a data format requirement of SEI coding, as shown in Table 3 below:

TABLE 3
SEI frame format table

| | | | | Universally | | | |
|---|---|---|---|---|---|---|---|
| | | | | unique | Custom | | Alignment |
| | | NALU | Payload | identifier | data | Custom | termination |
| Name | Start code | type | type | (UUID) | length | data | code |
| Data | 0x000000 01 | 0x06 | 0x05 | . . . | . . . | . . . | 0x 80 |
| Length | 4 bytes | 1 byte | 1 byte | 16 bytes | 2 bytes | N bytes | 1 byte |

A format of the SEI frame includes a start code, a NALU type, a payload type, a UUID, a custom data length, custom data, and alignment termination code. The payload type being 0x05 indicates compliance with an H264 standard format, the UUID is a service-defined identifier, a custom data length may be calculated from custom data, and the custom data is determined by a service party, with 0x80 padded at the end for alignment. The SEI frame may be inserted before the I frame or the P frame, and may be transmitted together with the video frame. In the foregoing examples, it may be ensured that the time for displaying or hiding the target promotion information is the same as the time for explaining the video, but the server has relatively low flexibility in secondary processing.

For example, FIG. 10B is a schematic flowchart of display of an explanation video and target promotion information according to another embodiment. A network transmission manner of a hypertext transfer protocol (HTTP) is used in FIG. 10B. The viewer terminal transmits the explanation video to the server, the server transmits the explanation video to the livestreamer terminal, the livestreamer terminal generates a stream mixing instruction based on the explanation video and the video livestreaming image, and transmits the stream mixing instruction to the server, and the server mixes a video frame of the explanation video with a video frame of the video livestreaming image based on the stream mixing instruction, to obtain a mixed video. The server delivers the mixed video to all terminals. The viewer terminal transmits the object identifier of the target promotion object and the display state of the target promotion information to the server, and the server distributes the object identifier of the target promotion object and the display state of the target promotion information to the terminals, to instruct the terminals to display the target promotion information according to the object identifier and the display state. The terminals herein include a livestreaming terminal, a viewer terminal A, a viewer terminal B, . . . , and a viewer terminal Z. In the foregoing examples, it is difficult that the time for displaying or hiding the target promotion information is the same as the time for explaining the video, but the server has high flexibility in secondary processing.

In some other embodiments, if the livestreamer terminal determines a plurality of pieces of target promotion information initiated by a same viewer account, a list of target promotion information is displayed on a viewer terminal in which the viewer account is located, and the viewer terminal determines selected target promotion information in response to a selection operation on one piece of target promotion information in the list. In addition, the selected target promotion information is transmitted to the server, so as to be forwarded to the livestreamer terminal, and the livestreamer terminal displays the selected target promotion information in the video livestreaming image.

For example, FIG. 11 is a schematic diagram of target promotion information according to some embodiments. A list of target promotion information in FIG. 11 includes a commodity 1 to a commodity 4, and a gift quantity of each commodity is further displayed, which are respectively 1, 2, 3, and 4. The 4 commodities are commodities associated with a same viewer account, and the livestreamer terminal confirms that the viewer account can display and explain the 4 commodities in the video livestreaming image. “Explain” in FIG. 11 is an explanation selection control. The viewer terminal determines a current promotion object from a plurality of commodities, and in response to a trigger operation on a selection control corresponding to the current promotion object, the viewer terminal transmits target promotion information corresponding to the current promotion object to a server. The target promotion information corresponding to the current promotion object is selected target promotion information. The server forwards the selected target promotion information to the livestreamer terminal, and the livestreamer terminal displays the selected target promotion information in the video livestreaming image and displays an explanation video corresponding to the selected target promotion information in an overlaid manner in the video livestreaming image.

Based on this, when a plurality of pieces of target promotion information are confirmed, a corresponding viewer account can select a promotion object that currently may be explained by using a list of target promotion information displayed on a viewer terminal. Based on this, the selected target promotion information can be displayed in the video livestreaming image, and a corresponding explanation video can also be displayed. In this way, when the viewer account does not need to activate an own video livestreaming room, target promotion information of the viewer account and a corresponding explanation video can be directly displayed in the video livestreaming room corresponding to the livestreamer account, thereby effectively improving user experience based on video interaction.

In some embodiments, in a process of displaying, in the video livestreaming image, target promotion information that the target information promotion request applies for display, a real-time captured explanation video regarding a target promotion object indicated by the target promotion information is displayed in the video livestreaming image. In this way, when the viewer account does not need to activate an own video livestreaming room, target promotion information of the viewer account and a corresponding explanation video can be directly displayed in the video livestreaming room corresponding to the livestreamer account. In this manner, the user is supported to apply for playing back an uploaded video in others' video livestreaming rooms by using the user's account, video playback manners are enriched, and user experience based on video interaction is effectively improved.

In some embodiments, the method further includes: canceling, if a video display duration of the target video is verified to reach a video duration that the target video playback application applies for, displaying the target video in the video livestreaming image.

For example, after determining that the video display duration of the target video reaches the video duration that the target video playback application applies for, the server transmits a video cancellation indication to the livestreamer terminal. After receiving the video cancellation indication, if the livestreamer terminal determines that the video display duration of the target video reaches the video duration that the target video playback application applies for, displaying the target video in the video livestreaming image is canceled, and the target promotion information corresponding to the target video is hidden in the video livestreaming image. The livestreamer terminal displays the video livestreaming image provided for the livestreamer account.

In some embodiments, if the video display duration of the target video is verified to reach the video duration that the target video playback application applies for, the target video is directly terminated and is quickly switched to display of a livestreamer video, thereby improving efficiency of video interaction.

In some embodiments, the method further includes: canceling, if a display duration of the target promotion information is verified to reach a promotion duration that the target information promotion request applies for, displaying the target promotion information in the video livestreaming image.

For example, when the server determines that the display duration of the target promotion information reaches the promotion duration that the target information promotion request applies for, the server transmits an information cancellation indication to the livestreamer terminal. After receiving the information cancellation indication, the livestreamer terminal cancels displaying the target promotion information in the video livestreaming image.

In some embodiments, if the display duration of the target promotion information reaches the promotion duration that the target information promotion request applies for, displaying the target promotion information in the video livestreaming image is directly canceled, thereby improving efficiency of video interaction.

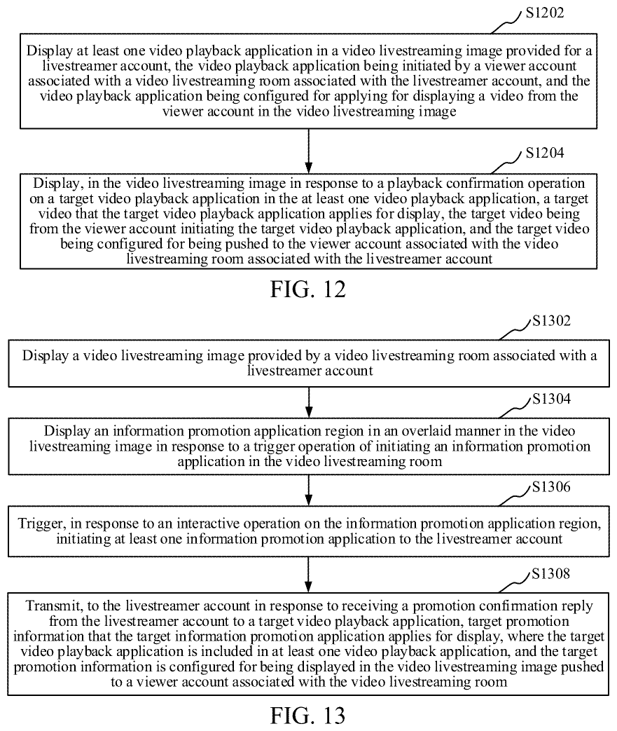

In some embodiments, as shown in FIG. 12, a video livestreaming-based interaction method is provided. For example, the method is applied to the livestreamer terminal 102 in FIG. 1, and includes the following operations:
Operation S1202: Display at least one video playback application in a video livestreaming image provided for a livestreamer account, the video playback application being initiated by a viewer account associated with a video livestreaming room associated with the livestreamer account, and the video playback application being configured for applying for displaying a video from the viewer account in the video livestreaming image.
Operation S1204: Display, in the video livestreaming image in response to a playback confirmation operation on a target video playback application in the at least one video playback application, a target video that the target video playback application applies for display, the target video being from the viewer account initiating the target video playback application, and the target video being configured for being pushed to the viewer account associated with the video livestreaming room associated with the livestreamer account.

For operation S1202 to operation S1204, refer to the foregoing parts of operation S602 and operation S604.

In some embodiments, the method further includes: displaying at least one information promotion request in the video livestreaming image; the information promotion request being initiated by the viewer account associated with the video livestreaming room associated with the livestreamer account; and displaying, in the video livestreaming image in response to a promotion confirmation operation on a target information promotion request in the at least one information promotion request, target promotion information that the target information promotion request applies for display; the target promotion information being configured for being pushed to the viewer account associated with the video livestreaming room associated with the livestreamer account.

After the livestreamer terminal completes operation S1202, in a process in which the livestreamer terminal displays an audio/video related to the livestreamer, after prompt information of the information promotion request is displayed in the video livestreaming image, in response to a trigger operation on the prompt information of the information promotion request, the livestreamer terminal displays an information promotion request list. The information promotion request list includes an information promotion request sublist initiated by at least one viewer account associated with the video livestreaming room associated with the livestreamer account. Each information promotion request sublist includes at least one information promotion request initiated by a same viewer account. In response to the promotion confirmation operation on the target information promotion request in the at least one information promotion request, the livestreamer terminal acquires the target promotion information corresponding to the target information promotion request transmitted by the viewer terminal. The livestreamer terminal displays the target promotion information in an overlaid manner in the video livestreaming image.

In some embodiments, before the information promotion request is transmitted, if the viewer account enters the video livestreaming room, it is determined that the viewer account is associated with the video livestreaming room associated with the livestreamer account, so that the viewer account can be allowed to transmit the information promotion request without considering whether the viewer account has a capability of activating the video livestreaming room, thereby simplifying the process of the information promotion request. In response to the promotion confirmation operation on the target information promotion request in the at least one information promotion request, the target promotion information that the target information promotion request applies for display is displayed in the video livestreaming image, which simplifies the process of information promotion and improves efficiency of video interaction.

In the foregoing video livestreaming-based interaction, at least one video playback application is displayed in a video livestreaming image provided for a livestreamer account, the video playback application is initiated by a viewer account associated with a video livestreaming room associated with the livestreamer account, and the video playback application is configured for applying for displaying a video from the viewer account in the video livestreaming image. Before the video playback application is transmitted, there is no need to consider whether the viewer account has a capability of activating a video livestreaming room, nor an account level of the viewer account. As long as the viewer account enters a video livestreaming room associated with a livestreamer account, the viewer account is associated with the livestreamer account, and the viewer account is allowed to transmit the video playback application to the livestreamer account. The livestreamer account may display, in the video livestreaming image in response to a playback confirmation operation on a target video playback application in the at least one video playback application, a target video that the target video playback application applies for display. The target video is from the viewer account initiating the target video playback application. The target video may be pushed to all viewer accounts associated with the video livestreaming room associated with the livestreamer account. In this manner, the user is supported to apply for playing back an uploaded video in others' video livestreaming rooms by using the user's account, video playback manners are enriched, promotion information needing to be displayed in a current video livestreaming room can be efficiently determined during the livestreaming, resulting in high efficiency, labor costs caused by implementation of negotiation preparation are reduced, and user experience based on video interaction is effectively improved.

The following describes a process from acquiring the video playback application to displaying the target promotion information by the livestreamer terminal.

Firstly, the livestreamer terminal is logged in with a livestreamer account, and activates, with the livestreamer account, a video livestreaming room associated with the livestreamer account. The livestreamer terminal displays a video livestreaming image provided for the livestreamer account.

Secondly, the livestreamer account receives a video playback request initiated by a viewer account associated with the video livestreaming room associated with the livestreamer account. The video playback request includes a video source type and a playback duration of a to-be-played-back video, the viewer account initiating the video playback request, and a quantity of virtual resources. The livestreamer terminal displays at least one video playback application. The video playback application is initiated by the viewer account associated with the video livestreaming room associated with the livestreamer account, and the video playback application is configured for applying for displaying a video from the viewer account in the video livestreaming image. In response to a playback confirmation operation on a target video playback application in the at least one video playback application, the livestreamer terminal performs same-screen display on the video livestreaming image and a target video that the target video playback application of the viewer account applies for display.

Next, in a process of displaying the video livestreaming image provided for the livestreamer account and the target video transmitted by the viewer account, the livestreamer terminal receives an information promotion request initiated by the viewer account associated with the video livestreaming room associated with the livestreamer account, where the information promotion request includes promotion information of a promotion object; and generates the information promotion request according to the information promotion request. The information promotion request includes at least one of the viewer account initiating the corresponding information promotion request, a promotion duration, and a quantity of virtual resources.

Then, in response to a trigger operation on a viewing entry of the information promotion request in the video livestreaming image provided for the livestreamer account, a browse region regarding the information promotion request is displayed in the video livestreaming image. Application information of each information promotion request is displayed in the browse region. The application information includes at least one of the viewer account initiating the corresponding information promotion request, a promotion duration, and a quantity of virtual resources.

Subsequently, in response to a promotion confirmation operation on a target information promotion request in the at least one information promotion request, the target promotion information that the target information promotion request applies for display is added to a list of interactive information associated with the video livestreaming room associated with the livestreamer account. The list of interactive information associated with the video livestreaming room is configured for the viewer account associated with the video livestreaming room to trigger an online transaction operation on the interactive information.

Finally, in a process in which the livestreamer terminal displays target promotion information and a real-time captured explanation video regarding a target promotion object indicated by the target promotion information, if a video display duration of the target video is verified to reach a video duration that the target video playback application applies for, displaying the target video in the video livestreaming image is canceled. If a display duration of the target promotion information is verified to reach a promotion duration that the target information promotion request applies for, displaying the target promotion information in the video livestreaming image is canceled.

In some embodiments, when the viewer account has a promotion requirement and a requirement for explaining corresponding promotion information, a video playback application is first transmitted to the livestreamer account. In this case, before the video playback application is transmitted, there is no need to consider whether the viewer account has a capability of activating a video livestreaming room, nor an account level of the viewer account. As long as the viewer account enters a video livestreaming room associated with a livestreamer account, the viewer account is associated with the livestreamer account, and the viewer account is allowed to transmit the video playback application to the livestreamer account. After the livestreamer terminal agrees, the target video corresponding to the target video playback application agreed to by the livestreamer terminal may be played back in the video livestreaming room, thereby enriching video playback manners. Then, there is no need to consider whether the viewer account has a capability of activating a video livestreaming room, nor an account level of the viewer account. The viewer account may directly transmit an information promotion request to the livestreamer account. After the livestreamer account agrees, target promotion information corresponding to the target information promotion request agreed to may be displayed in the video livestreaming room. Based on this, the target promotion information corresponding to the target promotion object and the target video may be simultaneously displayed in the video livestreaming room associated with the livestreamer account, thereby effectively improving user experience based on video interaction.

In some embodiments, as shown in FIG. 13, a video livestreaming-based interaction method is provided. For example, the method is applied to the viewer terminal 104 in FIG. 1, and includes the following operations:
Operation S1302: Display a video livestreaming image provided by a video livestreaming room associated with a livestreamer account.
Operation S1304: Display an information promotion request region in an overlaid manner in the video livestreaming image in response to a trigger operation of initiating an information promotion request in the video livestreaming room.

The information promotion request region is configured for displaying an information promotion request from a viewer account.

For example, the viewer terminal displays a list of interactive information, and in response to a trigger operation on the list of interactive information, initiates a trigger operation of an information promotion request, and the viewer terminal displays the information promotion request region in an overlaid manner in the video livestreaming image.

For example, in response to a trigger operation on an avatar icon of the livestreamer account, a trigger operation of an information promotion request is initiated, and the viewer terminal displays the information promotion request region in an overlaid manner in the video livestreaming image.

For example, after the viewer terminal previously initiates a video playback request to the livestreamer account and obtains a playback confirmation operation of the livestreamer account, the viewer terminal directly displays the information promotion request region in an overlaid manner in the video livestreaming image based on the received playback confirmation operation.

For example, in response to the playback confirmation operation on the target video playback application in the at least one video playback application, the livestreamer terminal transmits, to the server, information allowing an information promotion control to be displayed. The information includes an identifier of a viewer terminal that allows an information promotion control to be displayed. The server transmits the information allowing the information promotion control to be displayed to a viewer terminal corresponding to the identifier. After receiving the information allowing the information promotion control to be displayed, the viewer terminal displays the information promotion control in a video livestreaming image of the viewer terminal. The information promotion control is configured to trigger the viewer terminal to generate an information promotion request. In response to a trigger operation on the information promotion control in the video livestreaming image, the viewer terminal displays the information promotion request region in an overlaid manner in the video livestreaming image.

Operation S1306: Trigger, in response to an interactive operation on the information promotion request region, initiating at least one information promotion request to the livestreamer account.

In some embodiments, in the information promotion request region, the viewer terminal initiates an information promotion request to the livestreamer account, to instruct a livestreamer terminal in which the livestreamer account is located to generate a corresponding information promotion request based on the information promotion request. After receiving the at least one information promotion request, the livestreamer terminal performs operation S202. The interactive operation on the information promotion request region may be an operation of selecting at least one of candidate information promotion requests displayed in the promotion application region or may be an operation of editing a material in the promotion application region to generate at least one information promotion request.

Operation S1308: Transmit, to the livestreamer account in response to receiving a promotion confirmation reply from the livestreamer account to a target video playback application, target promotion information that the target information promotion request applies for display, where the target video playback application is included in at least one video playback application, and the target promotion information is configured for being displayed in the video livestreaming image pushed to a viewer account associated with the video livestreaming room.

In some embodiments, in response to receiving a promotion confirmation reply from the livestreamer account to a target video playback application, where the target video playback application is included in the at least one video playback application, the viewer terminal determines selected target promotion information from target promotion information corresponding to at least one target information promotion request, and transmits the selected target promotion information to the server to forward the selected target promotion information to the livestreamer terminal, and the livestreamer terminal displays the selected target promotion information in the video livestreaming image. Certainly, the server also simultaneously forwards the selected target promotion information to all viewer terminals connected to the video livestreaming room, so that all the viewers in the video livestreaming room see the selected target promotion information in respective viewer terminals.

In the foregoing video livestreaming-based interaction method, a video livestreaming image provided by a video livestreaming room associated with a livestreamer account is displayed; an information promotion request region is displayed in an overlaid manner in the video livestreaming image in response to a trigger operation of initiating an information promotion request in the video livestreaming room; and in response to an interactive operation on the information promotion request region, initiating at least one information promotion request to the livestreamer account is triggered. For example, as long as a viewer account enters the video livestreaming room associated with the livestreamer account, the viewer account is associated with the livestreamer account, and the viewer account is allowed to transmit the information promotion request to the livestreamer account. In response to receiving a promotion confirmation reply from the livestreamer account to a target video playback application, target promotion information that the target information promotion request applies for display is transmitted to the livestreamer account, where the target video playback application is included in at least one video playback application, and the target promotion information is configured for being displayed in the video livestreaming image pushed to a viewer account associated with the video livestreaming room. In this manner, the user is supported to apply for information promotion in others' video livestreaming rooms by using the user's account, video information promotion manners are enriched, promotion information needing to be displayed in a current video livestreaming room can be efficiently determined during the livestreaming, resulting in high efficiency, labor costs caused by implementation of negotiation preparation are reduced, and user experience based on video interaction is effectively improved.

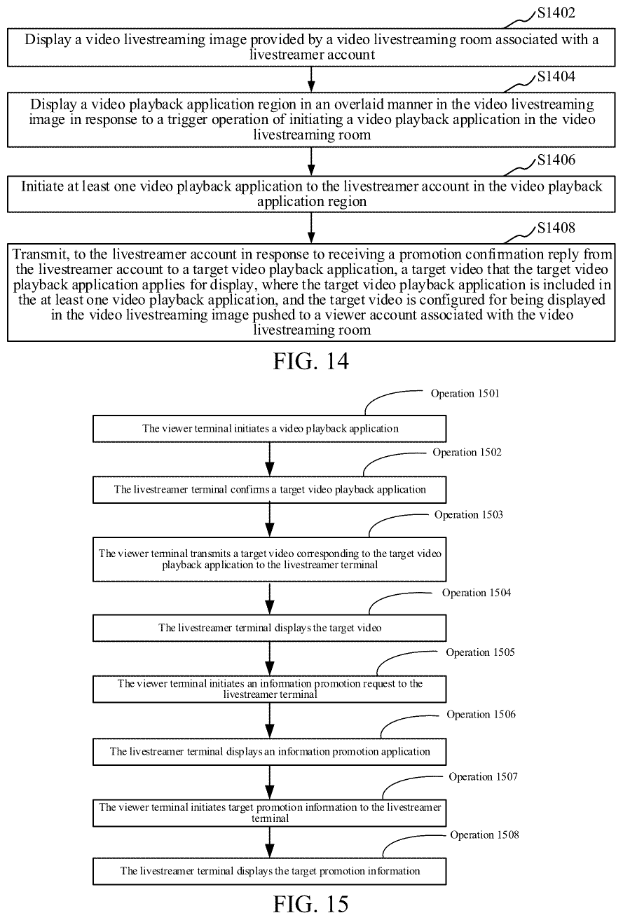

In some embodiments, as shown in FIG. 14, a video livestreaming-based interaction method is provided. For example, the method is applied to the viewer terminal 104 in FIG. 1, and includes the following operations:
Operation S1402: Display a video livestreaming image provided by a video livestreaming room associated with a livestreamer account.
Operation S1404: Display a video playback application region in an overlaid manner in the video livestreaming image in response to a trigger operation of initiating a video playback application in the video livestreaming room.

The video playback application region is configured for determining and displaying application information configured for applying for video playback. For example, the application information includes a video source type and a playback duration of a to-be-played-back video, and the video source type includes one of a local video and a captured video. For each viewer account connected to the video livestreaming room, if the viewer account has a video promotion requirement, the viewer account may initiate a video playback application to the livestreamer account.

For example, in response to a trigger operation on the video playback control in the video livestreaming image, the viewer terminal displays the video playback application region in an overlaid manner in the video livestreaming image.

Operation S1406: Initiate at least one video playback application to the livestreamer account in the video playback application region.

In some embodiments, in the video playback application region, the viewer terminal determines the video playback request based on application information configured for applying for video playback, and transmits the video playback request to the livestreamer terminal. In this way, the livestreamer terminal receives the video playback request initiated by the viewer account from the viewer terminal, and generates the video playback application according to the video playback request.

Operation S1408: Transmit, to the livestreamer account in response to receiving a promotion confirmation reply from the livestreamer account to a target video playback application, a target video that the target video playback application applies for display, where the target video playback application is included in the at least one video playback application, and the target video is configured for being displayed in the video livestreaming image pushed to a viewer account associated with the video livestreaming room.

In some embodiments, when the viewer terminal receives a playback confirmation reply from the livestreamer account to the target video playback application in the at least one video playback application, the viewer terminal transmits, to the livestreamer terminal, a target video that the target video playback application applies for display. The livestreamer terminal receives the target video. The livestreamer terminal acquires an image display parameter between video livestreamers, and generates a stream mixing instruction based on the image display parameter. The livestreamer terminal uploads the stream mixing instruction to the server. The server transmits a mixed video after performing same-screen mixing on the target video and the video livestreaming image according to the stream mixing instruction, and distributes the mixed video all terminals in the video livestreaming room by using the CDN, so that the target video is displayed in the video livestreaming image.

In some embodiments, the method further includes: displaying an information promotion request region in an overlaid manner in the video livestreaming image in response to a trigger operation of initiating an information promotion request in the video livestreaming room; triggering, in response to an interactive operation on the information promotion request region, initiating at least one information promotion request to the livestreamer account; and transmitting, to the livestreamer account in response to receiving a promotion confirmation reply from the livestreamer account to a target video playback application, target promotion information that the target information promotion request applies for display, where the target video playback application is included in at least one video playback application, and the target promotion information is configured for being displayed in the video livestreaming image pushed to a viewer account associated with the video livestreaming room.

After the viewer terminal completes operation S1406, in response to the playback confirmation operation on the target video playback application in the at least one video playback application, the livestreamer terminal transmits, to the server, information allowing an information promotion control to be displayed. The information includes an identifier of a viewer terminal that allows an information promotion control to be displayed. The server transmits the information allowing the information promotion control to be displayed to a viewer terminal corresponding to the identifier. After receiving the information allowing the information promotion control to be displayed, the viewer terminal displays the information promotion control in a video livestreaming image of the viewer terminal. The information promotion control is configured to trigger the viewer terminal to generate an information promotion request. The viewer terminal initiates an information promotion request to the livestreamer account in response to a trigger operation on the information promotion control in the video livestreaming image, to instruct the livestreamer terminal in which the livestreamer account is located to generate a corresponding information promotion request based on the information promotion request. After receiving the at least one information promotion request, the livestreamer terminal performs operation S202.

When the viewer terminal receives a promotion confirmation reply from the livestreamer account to a target information promotion request in at least one information promotion request, the viewer terminal determines selected target promotion information from target promotion information corresponding to at least one target information promotion request, and transmits the selected target promotion information to the server to forward the selected target promotion information to the livestreamer terminal, and the livestreamer terminal displays the selected target promotion information in the video livestreaming image. Certainly, the server also simultaneously forwards the selected target promotion information to all viewer terminals connected to the video livestreaming room, so that all the viewers in the video livestreaming room see the selected target promotion information in respective viewer terminals.

Based on this, when the video livestreaming image provided for the livestreamer account is displayed, the information promotion request is initiated by using the information promotion control, so that a corresponding information promotion request can be directly displayed subsequently in the video livestreaming image provided for the livestreamer account. In this way, when the viewer account does not need to activate an own video livestreaming room, target promotion information of the viewer account can be directly displayed in the video livestreaming room corresponding to the livestreamer account, video-based information promotion manners are enriched, promotion information needing to be displayed in a current video livestreaming room can be efficiently determined during the livestreaming, resulting in high efficiency, labor costs caused by implementation of negotiation preparation are reduced, and user experience based on video interaction is effectively improved.

In the foregoing video livestreaming-based interaction method, a video livestreaming image provided by a video livestreaming room associated with a livestreamer account is displayed; and a video playback application region is displayed in an overlaid manner in the video livestreaming image in response to a trigger operation of initiating a video playback application in the video livestreaming room. In this way, before the video playback application is transmitted, there is no need to consider whether the viewer account has a capability of activating a video livestreaming room, nor an account level of the viewer account. As long as the viewer account enters a video livestreaming room associated with a livestreamer account, the viewer account can initiate at least one video playback application to the livestreamer account in the video playback application region. In response to receiving a promotion confirmation reply from the livestreamer account to a target video playback application, a target video that the target video playback application applies for display is transmitted to the livestreamer account, where the target video playback application is included in the at least one video playback application, and the target video is configured for being displayed in the video livestreaming image pushed to a viewer account associated with the video livestreaming room. In this manner, the user is supported to apply for playing back an uploaded video in others' video livestreaming rooms by using the user's account, which enriches video information promotion manners, can efficiently determine, during the livestreaming, promotion information needing to be displayed in a current video livestreaming room, resulting in high efficiency, reduce labor costs caused by implementation of negotiation preparation, and effectively improve user experience based on video interaction.

This application further provides an application scenario. The above video livestreaming-based interaction method is applied to the application scenario. The video livestreaming-based interaction method is applied to the application scenario as follows: in an interaction scenario, to expand a promotion range of a product, a to-be-interacted party uses a viewer as a viewer to join a video livestreaming room associated with a livestreamer account related to a product type, and an account of the to-be-interacted party is a viewer account associated with the video livestreaming room. In this case, by using the video livestreaming-based interaction method provided in this application, a promotion range of product-related promotion information may be expanded, thereby improving efficiency of video interaction, without the need for the to-be-interacted party to activate an own video livestreaming room. At least one information promotion request is displayed in the video livestreaming image provided for the livestreamer account; the information promotion request being initiated by the viewer account associated with the video livestreaming room associated with the livestreamer account; and in response to a promotion confirmation operation on a target information promotion request in the at least one information promotion request, target promotion information that the target information promotion request applies for display is displayed in the video livestreaming image. The target promotion information is configured for being pushed to the viewer account associated with the video livestreaming room associated with the livestreamer account.

Certainly, this application is not limited thereto. The video livestreaming-based interaction method provided in this application may also be applied to another application scenario. For example, in a scenario of an online conference, a conference initiator activates a video livestreaming room, the video livestreaming room may be considered as an online conference room, and member accounts entering the video livestreaming room may be considered as viewer accounts associated with the video livestreaming room. Based on this, the viewer account may promote own work achievements by using the video livestreaming-based interaction method provided in some embodiments, thereby improving efficiency of video interaction.

The foregoing application scenarios are merely exemplary descriptions. Application of the video livestreaming-based interaction method according to some embodiments is not limited to the foregoing scenarios.

In a embodiment, FIG. 15 is a schematic flowchart of a video livestreaming-based interaction method according to another embodiment. Some embodiments relates to interaction among a livestreamer terminal, a viewer terminal having a promotion requirement, another viewer terminal having no promotion requirement, and a server. The livestreamer account activates, in the livestreamer terminal, a video livestreaming room associated with the livestreamer account, and the viewer account having the promotion requirement and another viewer account having no promotion requirement are connected to the video livestreaming room. In this case, the following operations are performed:

Operation 1501: The viewer terminal initiates a video playback application.

In some embodiments, the viewer terminal displays a video livestreaming image provided for the livestreamer account.

The viewer terminal displays a video playback application region in an overlaid manner in the video livestreaming image in response to a trigger operation on a video playback control in the video livestreaming image, and initiates at least one video playback request to the livestreamer account in the video playback application region. The video playback request includes a video source type and a playback duration of a to-be-played-back video. The video source type includes one of a local video and a captured video. The video playback request is configured for instructing the livestreamer terminal to generate at least one video playback application.

Operation 1502: The livestreamer terminal confirms a target video playback application.

In some embodiments, the livestreamer terminal displays at least one video playback application. The video playback application is initiated by a viewer account associated with a video livestreaming room associated with the livestreamer account, and the video playback application is configured for applying for displaying a video from the viewer account in the video livestreaming image.

For example, before the livestreamer terminal displays at least one video playback application, the livestreamer terminal receives a video playback request initiated by the viewer account associated with the video livestreaming room associated with the livestreamer account, the video playback request including a video source type and a playback duration of a to-be-played-back video; where the video source type includes one of a local video and a captured video; and the video playback application is generated according to the video playback request. When the video source type is a local video of the viewer terminal initiating the video playback request, the video playback request further includes the local video of the viewer terminal, a viewer account initiating the video playback request, and a quantity of virtual resources. When the video source type is a captured video of the viewer terminal initiating the video playback request, the video playback request further includes a viewer account initiating the video playback request and a quantity of virtual resources.

Operation 1503: The viewer terminal transmits a target video corresponding to the target video playback application to the livestreamer terminal.

In some embodiments, when receiving a playback confirmation reply from the livestreamer account to the target video playback application in the at least one video playback application, the viewer terminal transmits, to the livestreamer account, a target video that the target video playback application applies for display, to display the target video in the video livestreaming image.

Operation 1504: The livestreamer terminal displays the target video.

In some embodiments, in response to a playback confirmation operation on the target video playback application in the at least one video playback application, the livestreamer terminal displays a target video that the target video playback application applies for display in the video livestreaming image. The target video is from the viewer account initiating the target video playback application, and the target video is configured for being pushed to the viewer account associated with the video livestreaming room associated with the livestreamer account.

For example, in response to a playback confirmation operation on the target video playback application in the at least one video playback application, the livestreamer terminal performs same-screen display on the video livestreaming image and a target video that the target video playback application of the viewer account applies for display.

For example, the livestreamer terminal receives the target video that the target video playback application of the viewer account applies for display; the livestreamer terminal acquires an image display parameter regarding the video livestreaming room, the image display parameter being configured for performing same-screen display on the video livestreaming image and the target video; the livestreamer terminal generates a stream mixing instruction based on the image display parameter; the livestreamer terminal transmits the stream mixing instruction to the server; the livestreamer terminal receives a mixed video transmitted by the server after performing same-screen mixing on the target video and the video livestreaming image according to the stream mixing instruction; and the livestreamer terminal displays the mixed video. Certainly, the server further transmits the mixed video to the viewer terminal and other viewer terminals.

For example, in a process of displaying, in the video livestreaming image, target promotion information that the target information promotion request applies for display, a real-time captured explanation video regarding a target promotion object indicated by the target promotion information is displayed in the video livestreaming image.

If a video display duration of the target video is verified to reach a video duration that the target video playback application applies for, displaying the target video in the video livestreaming image is canceled.

Operation 1505: The viewer terminal initiates an information promotion request to the livestreamer terminal.

In some embodiments, the viewer terminal displays a video playback application region in an overlaid manner in the video livestreaming room in response to a trigger operation on an information promotion control in the video livestreaming image, and initiates an information promotion request to the livestreamer account in the video playback application region. The information promotion request includes promotion information of a promotion object, and the information promotion request is configured for instructing the livestreamer terminal to generate at least one information promotion request.

Operation 1506: The livestreamer terminal displays an information promotion request.

In some embodiments, the livestreamer terminal displays at least one information promotion request in the video livestreaming image. The information promotion request is initiated by a viewer account associated with the video livestreaming room associated with the livestreamer account.

In some embodiments, before the livestreamer terminal displays the at least one information promotion request, the livestreamer terminal receives an information promotion request initiated by the viewer terminal, the information promotion request including promotion information of a promotion object; and generates the information promotion request according to the information promotion request. The information promotion request includes at least one of the viewer account initiating the corresponding information promotion request, a promotion duration, and a quantity of virtual resources.

The livestreamer terminal displays, in response to a trigger operation on the viewing entry of the information promotion request in the video livestreaming image provided for the livestreamer account, a browse region regarding the information promotion request in the video livestreaming image. Application information of each information promotion request is displayed in the browse region. The application information includes at least one of the viewer account initiating the corresponding information promotion request, a promotion duration, and a quantity of virtual resources.

Operation 1507: The viewer terminal initiates target promotion information to the livestreamer terminal.

In some embodiments, when receiving a promotion confirmation reply from the livestreamer account to the target information promotion request in the at least one information promotion request, the viewer terminal transmits, to the livestreamer account, target promotion information that the target information promotion request applies for display, to display the target promotion information in the video livestreaming image.

Operation 1508: The livestreamer terminal displays the target promotion information.

In some embodiments, the livestreamer terminal displays, in the video livestreaming image in response to a promotion confirmation operation on the target information promotion request in the at least one information promotion request, target promotion information that the target information promotion request applies for display. The target promotion information is configured for being pushed to the viewer account associated with the video livestreaming room associated with the livestreamer account.

For example, in response to a promotion confirmation operation on the target information promotion request in the at least one information promotion request, the livestreamer terminal adds the target promotion information that the target information promotion request applies for display to a list of interactive information associated with the video livestreaming room associated with the livestreamer account. The list of interactive information associated with the video livestreaming room is configured for the viewer account associated with the video livestreaming room to trigger an online transaction operation on the interactive information. If a display duration of the target promotion information is verified to reach a promotion duration that the target information promotion request applies for, displaying the target promotion information in the video livestreaming image is canceled.

In the above video livestreaming-based interaction method, when the viewer account has a promotion requirement and a requirement for explaining corresponding promotion information, a video playback application is first transmitted to the livestreamer account. In this case, before the video playback application is transmitted, there is no need to consider whether the viewer account has a capability of activating a video livestreaming room, nor an account level of the viewer account. As long as the viewer account enters a video livestreaming room associated with a livestreamer account, the viewer account is associated with the livestreamer account, and the viewer account is allowed to transmit the video playback application to the livestreamer account. After the livestreamer terminal agrees, the target video corresponding to the target video playback application agreed to by the livestreamer terminal may be played back in the video livestreaming room, thereby enriching video playback manners. Then, there is no need to consider whether the viewer account has a capability of activating a video livestreaming room, nor an account level of the viewer account. The viewer account may directly transmit an information promotion request to the livestreamer account. After the livestreamer account agrees, target promotion information corresponding to the target information promotion request agreed to may be displayed in the video livestreaming room. Based on this, the target promotion information corresponding to the target promotion object and the target video may be simultaneously displayed in the video livestreaming room associated with the livestreamer account, thereby effectively improving user experience based on video interaction. In addition, when the viewer terminal initiates a video playback request to the livestreamer terminal, a quantity of virtual resources to be transmitted to the livestreamer account is determined, to bring revenue to the livestreamer account, and at the same time, a new way is added to acquire traffic and promote information for a common viewer account that does not have a capability of activating video livestreaming. In this way, user experience of both the viewer and the livestreamer is considered.

Although all the steps are displayed sequentially according to instructions of arrows in the flowcharts as referred to in all the embodiments, the steps are not necessarily executed sequentially in an order indicated by the arrows. Unless otherwise explicitly specified in this application, execution of the steps is not strictly limited, and the steps may be performed in other sequences. Moreover, at least some steps in the flowcharts as referred to in the embodiments may include a plurality of steps or a plurality of stages. The steps or stages are not necessarily executed completely at the same moment and may be executed at different moments. The steps or stages are not necessarily sequentially executed, and may be executed alternately with other steps or at least some steps or stages of other steps.

Based on a same inventive concept, some embodiments further provides a video livestreaming-based interaction apparatus configured to implement the foregoing video livestreaming-based interaction method. An implementation solution provided by the apparatus for resolving a problem is similar to an implementation solution described in the foregoing method. Therefore, for limitations on one or more following embodiments of the video livestreaming-based interaction apparatus, refer to the limitations on the foregoing video livestreaming-based interaction method.

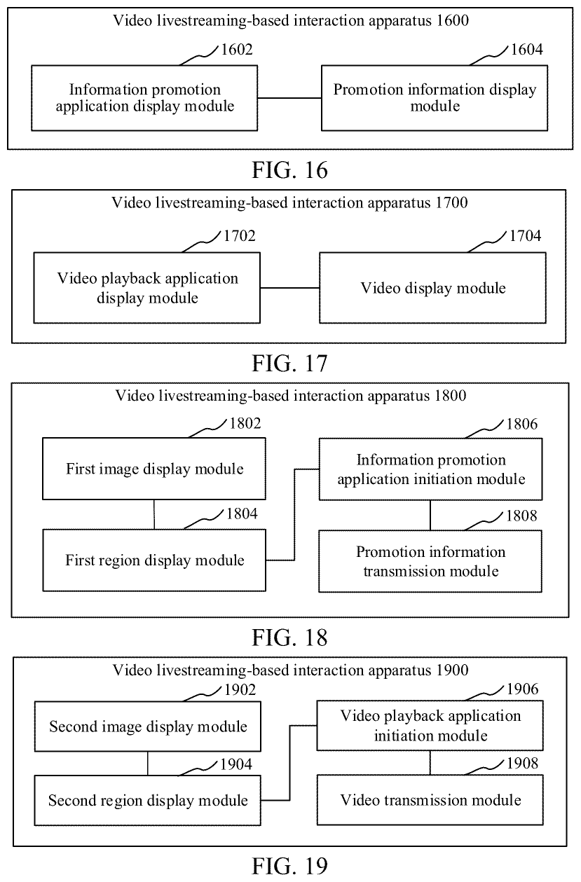

In some embodiments, as shown in FIG. 16, a video livestreaming-based interaction apparatus 1600 is provided, including: an information promotion request display module 1602 and a promotion information display module 1604.

The information promotion request display module 1602 is configured to display at least one information promotion request in a video livestreaming image provided for a livestreamer account. The information promotion request is initiated by a viewer account associated with a video livestreaming room associated with the livestreamer account.

The promotion information display module 1604 is configured to display, in the video livestreaming image in response to a promotion confirmation operation on a target information promotion request in the at least one information promotion request, target promotion information that the target information promotion request applies for display. The target promotion information is configured for being pushed to the viewer account associated with the video livestreaming room associated with the livestreamer account.

In some embodiments, the apparatus further includes a generation module. The generation module is configured to receive an information promotion request initiated by the viewer account associated with the video livestreaming room associated with the livestreamer account is received, the information promotion request including promotion information of a promotion object, and generate an information promotion request according to the information promotion request.

In some embodiments, the information promotion request further includes at least one of the viewer account initiating the corresponding information promotion request, a promotion duration, and a quantity of virtual resources.

In some embodiments, the information promotion request display module 1602 is configured to display the browse region regarding the information promotion request in the video livestreaming image provided for the livestreamer account; and display application information of each information promotion request in the browse region. The application information includes at least one of the viewer account initiating the corresponding information promotion request, a promotion duration, and a quantity of virtual resources.

In some embodiments, the information promotion request display module 1602 is configured to display, in response to a trigger operation on a viewing entry of the information promotion request in the video livestreaming image provided for the livestreamer account, the browse region regarding the information promotion request in the video livestreaming image.

In some embodiments, the promotion information display module 1604 is configured to add, in response to the promotion confirmation operation on the target information promotion request in the at least one information promotion request, the target promotion information that the target information promotion request applies for display to a list of interactive information associated with the video livestreaming room associated with the livestreamer account. The list of interactive information associated with the video livestreaming room is configured for the viewer account associated with the video livestreaming room to trigger an online transaction operation on the interactive information.

In some embodiments, the apparatus further includes a target video display module. The target video display module is configured to display at least one video playback application in the video livestreaming image, the video playback application being initiated by the viewer account associated with the video livestreaming room associated with the livestreamer account, the video playback application being configured for applying for displaying a video from the viewer account in the video livestreaming image; and display, in the video livestreaming image in response to a playback confirmation operation on a target video playback application in the at least one video playback application, a target video that the target video playback application applies for display. The target video is from the viewer account initiating the target video playback application, and the target video is configured for being pushed to the viewer account associated with the video livestreaming room associated with the livestreamer account.

In some embodiments, the generation module is further configured to receive a video playback request initiated by the viewer account associated with the video livestreaming room associated with the livestreamer account, the video playback request including a video source type and a playback duration of a to-be-played-back video; where the video source type includes one of a local video and a captured video; and generate the video playback application according to the video playback request.

In some embodiments, when the video source type is a local video of the viewer terminal initiating the video playback request, the video playback request further includes the local video of the viewer terminal, a viewer account initiating the video playback request, and a quantity of virtual resources. When the video source type is a captured video of the viewer terminal initiating the video playback request, the video playback request further includes a viewer account initiating the video playback request and a quantity of virtual resources.

In some embodiments, the target video display module is further configured to perform, in response to the playback confirmation operation on the target video playback application in the at least one video playback application, same-screen display on the video livestreaming image and the target video that the target video playback application of the viewer account applies for display.

In some embodiments, the target video display module is further configured to receive the target video that the target video playback application of the viewer account applies for display; acquire an image display parameter regarding the video livestreaming room, the image display parameter being configured for performing same-screen display on the video livestreaming image and the target video; generate a stream mixing instruction based on the image display parameter; transmit the stream mixing instruction to a server; receive a mixed video transmitted by the server after performing same-screen mixing on the target video and the video livestreaming image according to the stream mixing instruction; and display the mixed video.

In some embodiments, the target video display module is further configured to display, in the video livestreaming image in a process of displaying, in the video livestreaming image, target promotion information that the target information promotion request applies for display, a real-time captured explanation video regarding a target promotion object indicated by the target promotion information.

In some embodiments, the apparatus further includes a display cancellation module. The display cancellation module is configured to cancel, if a video display duration of the target video is verified to reach a video duration that the target video playback application applies for, displaying the target video in the video livestreaming image.

In some embodiments, the display cancellation module is further configured to cancel, if a display duration of the target promotion information is verified to reach a promotion duration that the target information promotion request applies for, displaying the target promotion information in the video livestreaming image.

Based on a same inventive concept, some embodiments further provides a video livestreaming-based interaction apparatus configured to implement the foregoing video livestreaming-based interaction method. An implementation solution provided by the apparatus for resolving a problem is similar to an implementation solution described in the foregoing method. Therefore, for limitations on one or more following embodiments of the video livestreaming-based interaction apparatus, refer to the limitations on the foregoing video livestreaming-based interaction method.

In some embodiments, as shown in FIG. 17, a video livestreaming-based interaction apparatus 1700 is provided, including: a video playback application display module 1702 and a video display module 1704.

The video playback application display module 1702 is configured to display at least one video playback application in a video livestreaming image provided for a livestreamer account. The video playback application is initiated by a viewer account associated with a video livestreaming room associated with the livestreamer account, and the video playback application is configured for applying for displaying a video from the viewer account in the video livestreaming image.

The video display module 1704 is configured to display, in the video livestreaming image in response to a playback confirmation operation on a target video playback application in the at least one video playback application, a target video that the target video playback application applies for display. The target video is from the viewer account initiating the target video playback application, and the target video is configured for being pushed to the viewer account associated with the video livestreaming room associated with the livestreamer account.

In some embodiments, the apparatus further includes a target promotion information display module. The target promotion information display module is configured to display at least one information promotion request in the video livestreaming image; the information promotion request being initiated by the viewer account associated with the video livestreaming room associated with the livestreamer account; and display, in the video livestreaming image in response to a promotion confirmation operation on a target information promotion request in the at least one information promotion request, target promotion information that the target information promotion request applies for display. The target promotion information is configured for being pushed to the viewer account associated with the video livestreaming room associated with the livestreamer account.

Based on a same inventive concept, some embodiments further provides a video livestreaming-based interaction apparatus configured to implement the foregoing video livestreaming-based interaction method. An implementation solution provided by the apparatus for resolving a problem is similar to an implementation solution described in the foregoing method. Therefore, for limitations on one or more following embodiments of the video livestreaming-based interaction apparatus, refer to the limitations on the foregoing video livestreaming-based interaction method.

In some embodiments, as shown in FIG. 18, a video livestreaming-based interaction apparatus 1800 is provided, including: a first image display module 1802, a first region display module 1804, an information promotion request initiation module 1806, and a promotion information transmission module 1808.

The first image display module 1802 is configured to display a video livestreaming image provided by a video livestreaming room associated with a livestreamer account.

The first region display module 1804 is configured to display an information promotion request region in an overlaid manner in the video livestreaming image in response to a trigger operation of initiating an information promotion request in the video livestreaming room.

The information promotion request initiation module 1806 is configured to trigger, in response to an interactive operation on the information promotion request region, initiating at least one information promotion request to the livestreamer account.

The promotion information transmission module 1808 is configured to transmit, to the livestreamer account in response to receiving a promotion confirmation reply from the livestreamer account to a target video playback application, target promotion information that the target information promotion request applies for display. The target video playback application is included in at least one video playback application, and the target promotion information is configured for being displayed in the video livestreaming image pushed to a viewer account associated with the video livestreaming room.

Based on a same inventive concept, some embodiments further provides a video livestreaming-based interaction apparatus configured to implement the foregoing video livestreaming-based interaction method. An implementation solution provided by the apparatus for resolving a problem is similar to an implementation solution described in the foregoing method. Therefore, for limitations on one or more following embodiments of the video livestreaming-based interaction apparatus, refer to the limitations on the foregoing video livestreaming-based interaction method.

In some embodiments, as shown in FIG. 19, a video livestreaming-based interaction apparatus 1900 is provided, including: a second image display module 1902, a second region display module 1904, a video playback application initiation module 1906, and a video transmission module 1908.

The second image display module 1902 is configured to display a video livestreaming image provided by a video livestreaming room associated with a livestreamer account.

The second region display module 1904 is configured to display a video playback application region in an overlaid manner in the video livestreaming image in response to a trigger operation of initiating a video playback application in the video livestreaming room.

The video playback application initiation module 1906 is configured to initiate at least one video playback application to the livestreamer account in the video playback application region.

The video transmission module 1908 is configured to transmit, to the livestreamer account in response to receiving a promotion confirmation reply from the livestreamer account to a target video playback application, a target video that the target video playback application applies for display, where the target video playback application is included in the at least one video playback application, and the target video is configured for being displayed in the video livestreaming image pushed to a viewer account associated with the video livestreaming room.

The modules in the foregoing video livestreaming-based interaction apparatus may be implemented entirely or partially by software, hardware, or a combination thereof. All the modules may be embedded in or independent of a processor in a computer device in a form of hardware, or may be stored in a memory in a computer device in a form of software, such that the processor may invoke and execute operations corresponding to the modules.

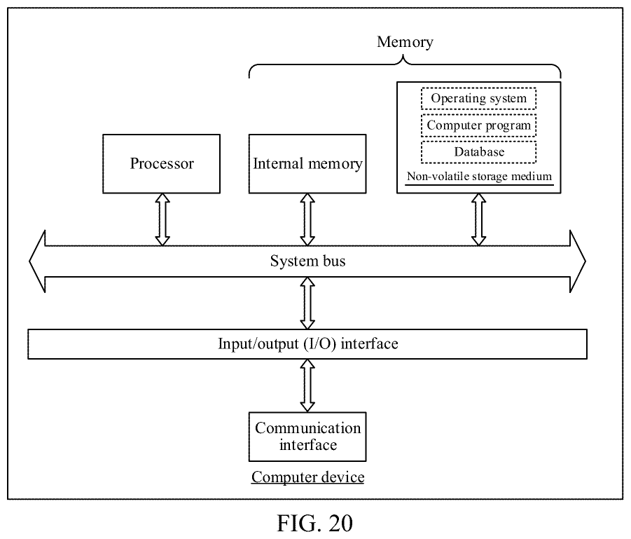

In some embodiments, a computer device is provided. The computer device may be a server or a terminal, and an internal structure thereof may be shown in FIG. 20. The computer device includes a processor, a memory, an input/output interface (I/O), and a communication interface. The processor, the memory, and the I/O interface are connected by using a system bus, and the communication interface is connected to the system bus by using the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for running of the operating system and the computer program in the non-volatile storage medium. The I/O interface of the computer device is configured to exchange information between the processor and an external device. The communication interface of the computer device is configured to connect to and communicate with an external terminal over a network. The computer program is executed by the processor to implement the foregoing video livestreaming-based interaction method.

It may be understood by those skilled in the art that the structure shown in FIG. 20 is merely a block diagram of part of a structure related to a solution of this application, and does not constitute a limitation on the computer device to which the solution of this application is applied. A computer device may include more or fewer components than those shown in the figure, or some components may be combined, or different component arrangements are provided.

In some embodiments, a computer device is further provided, including a memory and a processor. The memory has a computer program stored therein. The processor implements the steps in each method embodiment when executing the computer program.

In some embodiments, a computer-readable storage medium is provided, having a computer program stored therein. The computer program implements the steps in each method embodiment when executed by a processor.

In some embodiments, a computer program product is provided, including a computer program. The computer program implements the steps in each method embodiment when executed by a processor.

User information (including, but not limited to, user equipment information, user personal information, and the like) and data (including, but not limited to, data for analysis, stored data, displayed data, and the like) as referred to in this application are both information and data that are authorized by a user or fully authorized by all parties. Collection, use, and processing of related data may comply with relevant laws and regulations of relevant countries and regions.

A person of ordinary skill in the art may understand that all or some of procedures of the method in the foregoing embodiments may be implemented by a computer program instructing relevant hardware. The program may be stored in a non-volatile computer-readable storage medium. When the computer program is executed, the procedures of the foregoing method embodiments may be implemented. Any reference to a memory, a database or other media used in the embodiments provided in this application may include at least one of a non-volatile memory and a volatile memory. The non-volatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache. For the purpose of illustration rather than limitation, the RAM may be in various forms, such as a static random access memory (SRAM) or a dynamic random access memory (DRAM). The database as referred to in the embodiments provided in this application may include at least one of a relational database and a non-relational database. The non-relational database may include a blockchain-based distributed database, and is not limited thereto. The processor as referred to in the embodiments provided in this application may be a general-purpose processor, a central processing unit, a graphic processing unit, a digital signal processor, a programmable logic unit, a data processing logic unit based on quantum computing, and the like, and is not limited thereto.

Technical features of the foregoing embodiments may be randomly combined. To make description concise, not all possible combinations of the technical features in the foregoing embodiments are described. However, the combinations of these technical features shall be considered as falling within the scope described in this specification provided that no conflict exists.

The foregoing embodiments only describe several implementations of this application, which are described and in detail, but cannot be construed as a limitation on the patent scope of this application. For a person of ordinary skill in the art, several transformations and improvements can be made without departing from the idea of this application. These transformations and improvements belong to the protection scope of this application. Therefore, the protection scope of the patent of this application shall be subject to the appended claims.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A video livestreaming-based interaction method, performed by a computer device, the method comprising:
receiving at least one information promotion request from a requesting viewer account associated with a video livestreaming room of a livestreamer account
displaying the at least one information promotion request in a video livestreaming image provided for the livestreamer account; and
receiving a promotion confirmation operation selecting a target information promotion request from the at least one information promotion request;
displaying target promotion information corresponding to the target information promotion request in the video livestreaming image; and
pushing the target promotion information to at least one viewer account associated with a video livestreaming room.

2. The method according to claim 1,
wherein the information promotion request comprises promotion information of a promotion object.

3. The method according to claim 1,
wherein the information promotion request comprises at least one of an identifier of the requesting viewer account, a promotion duration, and a quantity of virtual resources.

4. The method according to claim 1, wherein the displaying the at least one information promotion request comprises:
displaying a browse region regarding the information promotion request in the video livestreaming image; and
displaying request information of each of the at least one information promotion request in the browse region, the request information comprising at least one of an identifier of the requesting viewer account, a promotion duration, and a quantity of virtual resources.

5. The method according to claim 4, wherein the displaying a browse comprises:
displaying, based on a trigger operation on a viewing entry of the information promotion request in the video livestreaming image, the browse region in the video livestreaming image.

6. The method according to claim 1, wherein the displaying target promotion information comprises:
adding, based on the promotion confirmation operation, the target promotion information to a list of interactive information associated with the video livestreaming room,
wherein the list of interactive information is configured for the at least one viewer account associated with the video livestreaming room to trigger online transaction operations.

7. The method according to claim 1, further comprising:
receiving at least one video playback request from the requesting viewer account;
displaying the at least one video playback request in the video livestreaming image;
receiving a playback confirmation operation selecting a target video playback request from the at least one video playback request;
displaying a target video corresponding to the target video playback request in the video livestreaming image; and
pushing the target video to the at least one viewer account associated with the video livestreaming room.

8. The method according to claim 7,
wherein the at least one video playback request comprises:
a video source type indicating one of a local video or a captured video; and
a playback duration of a video to be played.

9. The method according to claim 8,
wherein in a case that the video source type is a local video of a viewer terminal initiating the video playback request, the at least one video playback request further comprises the local video, an identifier of the requesting viewer account, and a quantity of virtual resources; and
in a case that the video source type is a captured video of the viewer terminal, the at least one video playback request further comprises an identifier of the requesting viewer account and a quantity of virtual resources.

10. The method according to claim 7, wherein the displaying a target video comprises:
performing, based on the playback confirmation operation, same-screen display on the video livestreaming image and the target video.

11. The method according to claim 10, wherein the performing same-screen display comprises:
receiving the target video from the requesting viewer account;
acquiring an image display parameter regarding the video livestreaming room, the image display parameter being configured for performing same-screen display;
generating a stream mixing instruction based on the image display parameter;
transmitting the stream mixing instruction to a server;
performing same-screen mixing on the target video and the video livestreaming image base d on the stream mixing instruction; and
receiving and displaying the mixed video.

12. The method according to claim 7, wherein the displaying a target video comprises:
displaying, during display of the target promotion information in the video livestreaming image, a real-time captured explanation video regarding a target promotion object indicated by the target promotion information.

13. The method according to claim 7, wherein the method further comprises:
canceling, in a case that a video display duration of the target video reaches a playback duration specified in the target video playback request, display of the target video in the video livestreaming image.

14. The method according to claim 7, wherein the method further comprises:
canceling, in a case that a display duration of the target promotion information reaches a promotion duration in the target information promotion request, display of the target promotion information in the video livestreaming image.

15. A video livestreaming-based interaction apparatus, comprising:
at least one memory configured to store program code; and
at least one processor configured to read the program code and operate as instructed by the program code, the program code comprising:
receiving code configured to cause at least one of the at least one processor to receive at least one information promotion request from a requesting viewer account associated with a video livestreaming room of a livestreamer account;
display code configured to cause at least one of the at least one processor to display the at least one information promotion request in a video livestreaming image provided for the livestreamer account; and
confirmation code configured to cause at least one of the at least one processor to receive a promotion confirmation operation selecting a target information promotion request from the at least one information promotion request;
promotion code configured to cause at least one of the at least one processor to display target promotion information corresponding to the target information promotion request in the video livestreaming image; and
pushing code configured to cause at least one of the at least one processor to push the target promotion information to at least one viewer account associated with a video livestreaming room.

16. The apparatus according to claim 15,
wherein the information promotion request comprises promotion information of a promotion object.

17. The apparatus according to claim 15,
wherein the information promotion request comprises at least one of an identifier of the requesting viewer account, a promotion duration, and a quantity of virtual resources.

18. The apparatus according to claim 15, wherein the display code is further configured to cause at least one of the at least one processor to:
display a browse region regarding the information promotion request in the video livestreaming image; and
display request information of each of the at least one information promotion request in the browse region, the request information comprising at least one of an identifier of the requesting viewer account, a promotion duration, and a quantity of virtual resources.

19. The apparatus according to claim 18, wherein the display code is further configured to cause at least one of the at least one processor to:
display, based on a trigger operation on a viewing entry of the information promotion request in the video livestreaming image, the browse region in the video livestreaming image.

20. A non-transitory computer-readable storage medium, storing computer code which, when executed by at least one processor, causes the at least one processor to at least:
receive at least one information promotion request from a requesting viewer account associated with a video livestreaming room of a livestreamer account;
display the at least one information promotion request in a video livestreaming image provided for the livestreamer account; and
receive a promotion confirmation operation selecting a target information promotion request from the at least one information promotion request;
display target promotion information corresponding to the target information promotion request in the video livestreaming image; and
push the target promotion information to at least one viewer account associated with a video livestreaming room.
